(19) United States
(12) Patent Application Publication
(10) Pub. No.: US 2026/0365771 A1
(43) Pub. Date: Nov. 19, 2026

(54) MECHANICALLY ROBUST AND CONDUCTIVE POLYAMPHOLYTE IONIC DIMER ELASTOMERS

(71) Applicant: UIF (UNIVERSITY INDUSTRY FOUNDATION), YONSEI UNIVERSITY, Seoul (KR)

(72) Inventors: Cheol Min PARK, Seoul (KR); Sang Young LEE, Seoul (KR); Tae Bin KIM, Seoul (KR); Kyeong Seok OH, Seoul (KR); Se Jung OH, Seoul (KR)

(73) Assignee: UIF (UNIVERSITY INDUSTRY FOUNDATION), YONSEI UNIVERSITY, Seoul (KR)

(21) Appl. No.: 19/660,354

(22) Filed: Apr. 28, 2026

(30) Foreign Application Priority Data
May 19, 2025 (KR) 10-2025-0064408

(51) Int. Cl. C08F 220/38

(52) U.S. Cl. CPC C08F 220/382; C08F 2500/21; C08F 2810/20

(57) ABSTRACT

A polymeric elastomer material with improved mechanical properties and ionic conductivity is disclosed. The polymeric elastomer material may comprise a cross-linked polymer chain; a cationic functional group branched from the polymer chain; and an anionic functional group that is ionically bonded to the cationic functional group and branched from the polymer chain.

### CROSS-REFERENCE TO RELATED APPLICATION

This application claims priority from Korean Patent Application No. 10-2025-0064408, filed on May 19, 2025, in the Korean Intellectual Property Office, and all the benefits accruing therefrom under 35 U.S.C. 119. The contents of the above application are incorporated herein in its entirety by reference.

### BACKGROUND

### Field

The present invention relates to the development of tough and highly ionically conductive ionic dimer elastomers for energy storage. More specifically, the present invention relates to the development of high-performance polymeric materials applicable to solid electrolyte-based energy storage devices and flexible electronics, and particularly to the development of polymeric elastomer materials based on ionic bond structures that simultaneously achieve superior mechanical properties and high ionic conductivity.

### Description of Related Art

Over the past few decades, the importance of polymer-based ionic materials has greatly increased in fields such as soft robotics, ionic skin, electronic devices, and energy storage technologies. Polymer-based ionic materials require a range of desirable properties, including transparency, ionic conductivity, mechanical strength, and electrochemical stability, and play a significant role in advanced applications such as solid-state batteries, supercapacitors, electronic devices, and soft actuators. In particular, ionic gels and elastomers, which are being developed to achieve long-term stability and high performance in various applications, have attracted significant attention for their potential to simultaneously achieve high ionic conductivity and mechanical strength.

However, current ionic elastomers face several major limitations in simultaneously enhancing ionic conductivity and mechanical properties. For instance, increasing the ion concentration to improve ionic conductivity leads to increased flexibility of the polymer chains, resulting in a decrease in mechanical strength. Conversely, introducing polar functional groups into polymer chains enhances mechanical strength but strengthens the interactions between polymer chains, increasing rigidity, raising the glass transition temperature (T_g), and ultimately reducing ionic conductivity. These characteristics serve as major factors limiting performance in real applications such as energy storage devices and iontronic products. Therefore, an innovative approach is required to simultaneously enhance ionic conductivity and mechanical strength.

Various strategies have been reported to overcome the trade-off between ionic conductivity and mechanical strength in ionic elastomers. Representative approaches include the control of phase separation between the ion transport domain and the mechanical properties domain, the regulation of ionic conductivity through macromolecular structures, the formation of crosslinked networks via interactions between three-dimensional network polymers and ions, and the development of polyampholytes that utilize ionic bonding structures between polymer chains to simultaneously enhance mechanical strength and ionic conductivity. In particular, polyampholytes have attracted attention compared to other material approaches due to their unique supramolecular structures formed through inter- and intra-chain ionic bond complexation.

Polyampholyte elastomers are often developed by blending ionic polymers with opposite charges, inducing ionic bonding between the polymer chains and forming a double-stranded ionic polymer structure. This approach maintains mechanical strength through electrostatic interactions between polymer chains while simultaneously exhibiting ionic conductivity based on ion dissociation and migration. Polyampholytes with high ionic conductivity have been reported to be fabricated with additional ion doping, making them potentially suitable for various applications including strain sensors, gel electrolytes, and supercapacitors. Furthermore, their use as dielectric materials without additional ion doping has also been previously reported. However, according to previous research, most conductive polyampholytes exhibit high stretchability but low mechanical strength. After blending the ionic polymers, counter-ions dissociated from each ionic polymer may remain due to low removal efficiency arising from slow ion diffusion, and the low ionic bond energy within the polyampholyte reduces mechanical stability.

The present invention presents novel ionic dimers (IDs) with strong ionic bonds between imidazolium and sulfonate functional groups. Subsequent copolymerization of the IDs with a cross-linkable moiety led to the development of a novel polyampholyte ID elastomer (IDE) with high mechanical strength. By adding Lithium bis(trifluoromethanesulfonyl)imide (LiTFSI) salt to the IDE, a high ionic conductivity of approximately 0.82 mS cm⁻¹ and a high lithium ion transference number (tLi⁺) of 0.79 were achieved, as the ionic bond structure within the IDE facilitates Lit ion transport. The IDE with LiTFSI exhibited excellent mechanical properties, with a tensile strength of 27.4 MPa and a Young's modulus of 211 MPa. The mechanically robust and conductive IDE functions as a resistive-type iontronic sensor, demonstrating high sensitivity (gauge factor=2.92) and maintaining stable resistance under deformation for approximately 400 cycles. Furthermore, the IDE serves as a polymer electrolyte in a pouch-type all-solid-state battery (ASSB), achieving stable capacity at a high current density of 1.0 C (4.0 mA cm⁻²) under ambient conditions (25 °C, 0.2 MPa).

### SUMMARY

The problem to be solved by the present invention is to overcome the limitations of conventional polymer electrolytes in which ionic conductivity and mechanical properties are in trade-off, and to realize a polymer network with high ionic bonding based on a structure in which counter-ions have been efficiently removed. This enables the provision of a material system capable of securing physical stability without loss of conductivity, and enhances the applicability to various lithium-based energy storage devices or flexible electronic devices. In particular, by simultaneously exploiting the self-assembly property and cross-linking reactivity of ionic dimers, there is potential to contribute to a simplified synthetic process that minimizes the need for additional auxiliary materials or additives.

More specifically, the present invention aims to develop an ionic bond-based polymeric elastomer by removing approximately 99% of counter-ions at the ionic monomer stage rather than at the ionic polymer stage, and the material is intended to simultaneously achieve and maintain high mechanical properties and high ionic conductivity through blending with LiTFSI salt. In addition, the synthesized polymeric elastomer has the potential to be utilized as a body-attachable stress-responsive sensor through blending with LiTFSI salt, and the present invention further aims to confirm the potential for application as a solid electrolyte in future lithium metal batteries through interfacial stability analysis with a lithium metal anode.

In one aspect, the present invention provides a polymeric elastomer material with improved mechanical properties and ionic conductivity, comprising: a cross-linked polymer chain; a cationic functional group branched from the polymer chain; and an anionic functional group that is ionically bonded to the cationic functional group and branched from the polymer chain.

In one embodiment, the cross-linked polymer chain may comprise a poly acrylate-based chain.

In one embodiment, the cationic functional group may comprise an imidazolium-based cation.

In one embodiment, the imidazolium-based cation may be derived from AEBI (1-(2-Acryloyloxyethyl)-3-butylimidazolium).

In one embodiment, the anionic functional group may comprise a sulfonate-based anion.

In one embodiment, the sulfonate-based anion may be derived from SPA (3-Sulfopropyl Acrylate).

In one embodiment, the polymer chain may be further cross-linked with PEGDA (Poly (ethylene glycol) diacrylate).

In one embodiment, the polymeric elastomer material may further comprise mobile lithium (Li) cations and TFSI (bis(trifluoromethanesulfonyl)imide) anions therein.

In another aspect, the present invention provides a method of manufacturing a polymeric elastomer material with improved mechanical properties and ionic conductivity, comprising: mixing a cationic monomer comprising a polymerizable functional group and a cationic functional group, a counter-anion of the cationic monomer, an anionic monomer comprising a polymerizable functional group and an anionic functional group, and a counter-cation of the anionic monomer; removing a precipitate formed by the counter-anion and the counter-cation; and cross-linking the cationic monomer and the anionic monomer.

In one embodiment, the counter-anion may comprise Br⁻ and the counter-cation may comprise K⁺.

In one embodiment, the cationic monomer may comprise AEBI (1-(2-Acryloyloxyethyl)-3-butylimidazolium).

In one embodiment, the anionic monomer may comprise SPA (3-Sulfopropyl Acrylate).

In one embodiment, the cross-linking may comprise cross-linking by UV photopolymerization or chemical cross-linking.

In one embodiment, the method may further comprise adding LiTFSI (Lithium bis(trifluoromethanesulfonyl)imide) salt prior to the cross-linking.

In one embodiment, the method may further comprise further cross-linking the cationic monomer and the anionic monomer with PEGDA (Poly (ethylene glycol) diacrylate).

Specifically, the present invention has the following configuration and operation. First, high-purity ionic dimers are synthesized through a precipitation reaction that removes 99% or more of counter-ions using cationic and anionic monomers, and are then fabricated into ionic bond-based polymeric elastomers via UV photopolymerization and chemical cross-linking. Second, the present invention is characterized by the ability to simultaneously secure high ionic conductivity and excellent mechanical properties even when a high concentration of LiTFSI salt is added. Third, the ionic bond-based polymeric elastomer structure ensures high ionic dissociation and mobility while maintaining robust physical properties.

The effect of the present invention lies in the ability to realize an elastomer in which both mechanical strength and ion mobility are simultaneously enhanced through an ionic bond-based polymer network. Such a structure may help alleviate the lack of fluidity and mechanical damage problems observed in conventional materials, and may advantageously contribute to the formation of stable ion transport pathways even in the solid state. Furthermore, owing to the property of maintaining electrical characteristics while preserving the physical structure under external stress, the applicability of the present invention can be extended to various fields such as energy storage devices and strain-responsive sensors.

Specifically, the present invention resolves the inherent problems of solid electrolytes and can simultaneously realize superior mechanical properties and high ionic conductivity. These characteristics hold the potential to be utilized as key materials in next-generation energy storage devices and flexible electronic devices. In particular, when applied to sensors and lithium metal batteries, the material possesses structural and electrochemical properties capable of delivering excellent performance, and thus has the potential to operate stably in various real-use environments.

### BRIEF DESCRIPTION OF DRAWINGS

FIG. 1A is a drawing illustrating the fabrication process and structure in which ionic monomers [AEBI]Br and K[SPA] are mixed and stirred at 70 °C for 24 hours, the counter-ions Br⁻ and K⁺ are removed via a precipitation reaction to obtain the [AEBI][SPA] dimer, and a cross-linking agent is then added to polymerize into an IDE via UV curing.

FIG. 1B is a drawing illustrating the absolute self-diffusion coefficients of protons of the [SPA]⁻ and [AEBI]⁺ ionic monomers measured using PFG-NMR equipment at 25 °C, shown together with the chemical structures of each monomer.

FIG. 1C is a drawing illustrating the GPC elution curves of polymerized ID samples using deionized water as the solvent and PEG/PEO as standards.

FIG. 1D is a drawing illustrating the glass transition temperatures (Tg) of [AEBI]Br, K[SPA], and IDE obtained from DSC heating curves.

FIG. 2A is a drawing illustrating the FT-IR spectra of IDE and IDE/LiTFSI (imidazole ring stretching peak: 1562 cm⁻¹, SO₃⁻ symmetric stretching peak: 10³⁶ cm⁻¹).

FIG. 2B is a drawing illustrating the temperature dependence of ionic conductivity (σ) and activation energy (Eₐ) of IDE/LiTFSI X/Y.

FIG. 2C is a drawing illustrating the ⁷Li⁺ diffusion coefficients of IDE/LiTFSI X/Y measured by PFG-NMR.

FIG. 2D is a drawing illustrating the XRD patterns of IDE/LiTFSI_1/1 and IDE/LiTFSI_1/2.

FIG. 2E is a drawing illustrating the time-dependent current profile of a Li∥Li symmetric cell using IDE/LiTFSI_1/1 under a 10 mV polarization condition, along with the EIS spectra and equivalent circuit before and after polarization.

FIG. 2F is a drawing illustrating a Walden plot of Λ versus τg for IDE/LiTFSI_1/1, shown together with literature data for PEO₉LiTFSI (25-65 °C), PEO₁₂LiTFSI (−35 to −5 °C), and (AgI)_{0.5}—(AgPO₃)_{0.5}, as well as the ideal Walden line with a slope of 1.

FIG. 2G is a drawing illustrating the LSCM surface morphology image of IDE/LiTFSI_1/1.

FIG. 2H is a drawing illustrating photographs of IDE/LiTFSI_1/1 in a large-area and elongated state.

FIG. 2I is a drawing illustrating a schematic of ion dissociation and ion migration through the effect of ionic bonding channels.

FIG. 3A is a drawing illustrating the tensile stress-strain curves of IDE/LiTFSI X/Y.

FIG. 3B is a drawing illustrating a comparison of calculated values of Young's modulus and toughness of IDE/LiTFSI_X/Y.

FIG. 3C is a drawing illustrating a photograph of an IDE/LiTFSI_1/1 sample capable of lifting a 5 kg weight (sample dimensions: 4.0×1.5×0.2 cm³).

FIG. 3D is a drawing illustrating the G′ and G″ values of IDE/LiTFSI_8/1 and IDE/LiTFSI_1/2 in the frequency range of 0.1-100 Hz.

FIG. 3E is a drawing illustrating the tensile stress-strain curve of an IDE/LiTFSI_8/1 sample containing a notch (notch length: 20% of sample width).

FIG. 3F is a drawing illustrating the compressive load curves of IDE/LiTFSI_X/Y at a compressive strain of 80%.

FIG. 3G is a drawing illustrating the Young's modulus and tensile strength of IDE/LiTFSI compared with reported polyampholyte, dielectric gel, and ionic gel-based materials.

FIG. 3H is a drawing illustrating the toughness and tensile strength of IDE/LiTFSI compared with reported polyampholyte, dielectric gel, and ionic gel-based materials.

FIG. 3I is a drawing illustrating the Young's modulus and ionic conductivity of IDE/LiTFSI compared with reported polyampholyte, dielectric gel, and ionic gel-based materials.

FIG. 4A is a drawing illustrating photographs of IDE/LiTFSI_8/1 in strong adhesion to glass, aluminum, PET, and copper substrates.

FIG. 4B is a drawing illustrating a schematic of the lap-shear test procedure and a demonstration photograph of IDE/LiTFSI_8/1 lifting a 2 kg weight.

FIG. 4C is a drawing illustrating the maximum adhesion strength-displacement curves obtained from lap-shear tests of IDE/LiTFSI_X/Y (dimensions: 2.0×2.0×0.1 cm³) adhered to various substrates.

FIG. 4D is a drawing illustrating the force-displacement curves obtained from 90° peel tests of IDE/LiTFSI_X/Y adhered to various substrates.

FIG. 4E is a drawing illustrating photographs of the sample during the 90° peel test.

FIG. 4F is a drawing illustrating a schematic of the adhesion mechanism between IDE/LiTFSI_X/Y and the substrates.

FIG. 5A is a drawing illustrating a schematic of a resistive-type iontronic sensor for strain sensing.

FIG. 5B is a drawing illustrating the initial electrical resistance graph of IDE/LiTFSI_X/Y.

FIG. 5C is a drawing illustrating a photograph of IDE/LiTFSI_1/2 operating as an ionically conductive material to illuminate a red LED bulb (dimensions: 2.0×1.0×0.1 cm³).

FIG. 5D is a drawing illustrating the gauge factor (GF) measurements under various tensile strains, reflecting the sensitivity of the sensor to external forces.

FIG. 5E is a drawing illustrating the resistance change response of an IDE/LiTFSI_1/2-based resistive-type iontronic sensor under continuous tensile strain.

FIG. 5F is a drawing illustrating stable resistance change cycles over 400 repeated loading-unloading cycles under a 20% strain condition.

FIG. 6A is a drawing illustrating the voltage profile of a Li∥Li symmetric cell using IDE/LiTFSI_1/1 at a current density of 1.0 mA cm⁻² and a capacity of 1.0 mAh cm⁻².

FIG. 6B is a drawing illustrating the EIS spectra of an IDE/LiTFSI_1/1-based Li∥Li symmetric cell after the 1st and 100th cycles.

FIG. 6C is a drawing illustrating the cycling performance of a pouch-type cell (dimensions: 2× 2 cm²) at a charge/discharge current density of 1.0 C(=4 mAh cm⁻²)/1.0 C, a voltage range of 3.0-4.3 V, and a temperature of 25 °C.

FIG. 6D is a drawing illustrating the charge/discharge voltage profiles of an ASSB before and after bending at a bending radius of 5 mm and a deformation rate of 30 mm min⁻¹, along with a photograph of a multiply-folded ASSB operating an LED lamp.

FIG. 6E is a drawing illustrating the safety test of an IDE/LiTFSI_1/1-based ASSB, showing stable operation of an LED lamp even after the cell is vertically cut in half or exposed to flame.

FIG. 7 is a drawing illustrating the ionic bond-based dimer synthesis method via a counter-ion precipitation reaction (product yield: 98.38%).

FIG. 8A is a drawing illustrating the ¹H-NMR spectrum of the [AEBI][SPA] dimer in D₂O.

FIG. 8B is a drawing illustrating the ¹³C-NMR spectrum of the [AEBI][SPA] dimer in D₂₀.

FIG. 9 is a drawing illustrating the ¹H-NMR spectrum of IDE in D₂O, showing the disappearance of the acrylate proton signals of the [AEBI][SPA] dimer at 6.4, 6.1, and 5.9 ppm (yellow box).

FIG. 10A is a drawing illustrating the ¹H PFG-NMR plot of the [SPA]⁻ monomer in the solvent-free state.

FIG. 10B is a drawing illustrating the ¹H PFG-NMR plot of the [AEBI]⁺ monomer in the solvent-free state.

FIG. 10C is a drawing illustrating the Nyquist plot of the [AEBI][SPA] dimer measured at 25 °C.

FIG. 11 is a drawing illustrating the DSC heating curves and labeled glass transition temperatures (Tg) of K[SPA], [AEBI]Br, and [AEBI][SPA].

FIG. 12 is a drawing illustrating a schematic of the fabrication process of IDE/LiTFSI, showing that the ID solution comprises PEGDA, a photoinitiator, and a solvent.

FIG. 13 is a drawing illustrating the transmittance spectra of IDE and IDE/LiTFSI_1/2.

FIG. 14 is a drawing illustrating the thermal stability of IDE and IDE/LiTFSI_1/2 near 150 °C and the residual solvent content in the 30-150 °C range (IDE: 94.52%, IDE/LiTFSI_1/2:96. 81%) as obtained from TGA curves (solvent: ethanol).

FIG. 15A is a drawing illustrating the DSC heating curves and labeled glass transition temperatures of IDE and IDE/LiTFSI.

FIG. 15B is a drawing illustrating a comparison of Tg values of IDE and IDE/LiTFSI based on DSC heating curves.

FIG. 16 is a drawing illustrating the ATR FT-IR spectra of IDE and IDE/LiTFSI (imidazole ring stretching peak: 1562 cm⁻¹, SO₃ symmetric stretching peak: 10³⁶ cm⁻¹)

FIG. 17 is a drawing illustrating the ⁷Li PFG-NMR plots of IDE/LiTFSI as a function of LiTFSI concentration.

FIG. 18 is a drawing illustrating the variation of activation energy (Eₐ) and ionic conductivity (6) of IDE/LiTFSI_1/1 at various temperatures (solvent: ethanol).

FIG. 19 is a drawing illustrating the thermal stability of IDE and IDE/LiTFSI_1/2 near 150 °C and the residual solvent content in the 50-150 °C range (IDE: 93.6%, IDE/LiTFSI_1/2:94. 7%) as obtained from TGA curves (solvent: DMF).

FIG. 20A is a drawing illustrating the frequency sweep results of IDE/LiTFSI_1/1 measured in the temperature range of 25-80 °C, showing G′ and G″ values as a function of angular frequency (@) at each temperature.

FIG. 20B is a drawing illustrating the master curve of IDE/LiTFSI_1/1, constructed using the shifted angular frequency (a_{T}ω) obtained by time-temperature superposition at a reference temperature of 15 °C, where the glass relaxation time is calculated as τₒ=1/ωₒ based on the angular frequency ωₒ at which G′=G″.

FIG. 21 is a drawing illustrating G′ and G″ of IDE/LiTFSI_4/1 and IDE/LiTFSI_1/1 measured in the frequency range of 0.1-100 Hz.

FIG. 22 is a drawing illustrating photographs of the notched tensile stress-strain test of the IDE/LiTFSI_8/1 sample.

FIG. 23A is a drawing illustrating a comparison of Young's modulus and tensile strength of IDE/LiTFSI_X/Y with previously reported polyampholytes, polyampholytes containing dielectric gels, and ionic gels.

FIG. 23B is a drawing illustrating a comparison of Young's modulus and toughness of IDE/LiTFSI_X/Y with previously reported polyampholytes, polyampholytes containing dielectric gels, and ionic gels.

FIG. 23C is a drawing illustrating a comparison of toughness and tensile strength of IDE/LiTFSI_X/Y with previously reported polyampholytes, polyampholytes containing dielectric gels, and ionic gels.

FIG. 23D is a drawing illustrating a comparison of Young's modulus and ionic conductivity of IDE/LiTFSI_X/Y with previously reported polyampholytes, polyampholytes containing dielectric gels, and ionic gels.

FIG. 23E is a drawing illustrating a comparison of tensile strength and ionic conductivity of IDE/LiTFSI_X/Y with previously reported polyampholytes, polyampholytes containing dielectric gels, and ionic gels.

FIG. 23F is a drawing illustrating a comparison of toughness and ionic conductivity of IDE/LiTFSI_X/Y with previously reported polyampholytes, polyampholytes containing dielectric gels, and ionic gels.

FIG. 24A is a drawing illustrating a comparison of toughness and tensile strength of IDE/LiTFSI_X/Y with previously reported ionic elastomers, including those employing crosslinking network, phase separation, or supramolecular interaction methods.

FIG. 24B is a drawing illustrating a comparison of toughness and ionic conductivity of IDE/LiTFSI_X/Y with previously reported ionic elastomers, including those employing crosslinking network, phase separation, or supramolecular interaction methods.

FIG. 24C is a drawing illustrating a comparison of Young's modulus and ionic conductivity of IDE/LiTFSI_X/Y with previously reported ionic elastomers, including those employing crosslinking network, phase separation, or supramolecular interaction methods.

FIG. 24D is a drawing illustrating a comparison of Young's modulus and tensile strength of IDE/LiTFSI_X/Y with previously reported ionic elastomers, including those employing crosslinking network, phase separation, or supramolecular interaction methods.

FIG. 24E is a drawing illustrating a comparison of Young's modulus and toughness of IDE/LiTFSI_X/Y with previously reported ionic elastomers, including those employing crosslinking network, phase separation, or supramolecular interaction methods.

FIG. 25A is a drawing illustrating the adhesion strength-displacement curves obtained from lap-shear tests of IDE/LiTFSI_8/1 adhered to different substrates.

FIG. 25B is a drawing illustrating the adhesion strength-displacement curves obtained from lap-shear tests of IDE/LiTFSI_4/1 adhered to different substrates.

FIG. 25C is a drawing illustrating the adhesion strength-displacement curves obtained from lap-shear tests of IDE/LiTFSI_1/1 adhered to different substrates.

FIG. 25D is a drawing illustrating the adhesion strength-displacement curves obtained from lap-shear tests of IDE/LiTFSI_1/2 adhered to different substrates.

FIG. 26A is a drawing illustrating the force-displacement curves obtained from 90° peel tests of IDE/LiTFSI_8/1 adhered to various substrates.

FIG. 26B is a drawing illustrating the force-displacement curves obtained from 90° peel tests of IDE/LiTFSI_4/1 adhered to various substrates.

FIG. 26C is a drawing illustrating the force-displacement curves obtained from 90° peel tests of IDE/LiTFSI_1/1 adhered to various substrates.

FIG. 26D is a drawing illustrating the force-displacement curves obtained from 90° peel tests of IDE/LiTFSI_1/2 adhered to various substrates.

FIG. 27A is a drawing illustrating a schematic for analyzing the stability of a resistive-type iontronic sensor by utilizing the load-bearing characteristics of IDE/LiTFSI_X/Y devices.

FIG. 27B is a drawing illustrating an IDE/LiTFSI_X/Y device exhibiting stable resistance behavior for 1 hour under a 5 kg load.

FIG. 28 is a drawing illustrating scanning electron microscopy (SEM) images of the lithium metal anode surface with IDE/LiTFSI applied after 100 hours of cycling tests.

FIG. 29A is a drawing illustrating a photograph of IDE/LiTFSI_1/1 in a bent state, demonstrating high deformability and flexibility.

FIG. 29B is a drawing illustrating a photograph of IDE/LiTFSI_1/1 in a twisted state, demonstrating high deformability and flexibility.

### DETAILED DESCRIPTIONS

Hereinafter, embodiments of the present invention will be described in detail with reference to the accompanying drawings. Since the present invention may be embodied in various forms and may be modified in various ways, specific embodiments are illustrated in the drawings and described in detail in the text. However, this is not intended to limit the present invention to the specific disclosed forms, and should be understood to include all modifications, equivalents, and substitutes falling within the spirit and scope of the present invention. Like reference numerals have been used for like elements throughout the description of each drawing. In the accompanying drawings, the dimensions of structures are shown enlarged relative to actual dimensions for clarity of the present invention.

The terminology used in the present application is used only to describe specific embodiments and is not intended to limit the present invention. Singular expressions include plural expressions unless the context clearly indicates otherwise. In the present application, terms such as “comprise” or “have” are intended to designate the presence of features, numbers, steps, operations, components, or combinations thereof described in the specification, and should be understood not to preclude in advance the possibility of the presence or addition of one or more other features, numbers, steps, operations, components, or combinations thereof. In the context of the present specification, terms such as “about” may mean approximately ±1%, approximately ±2%, approximately ±3%, approximately ±4%, approximately ±5%, approximately ±6%, approximately ±7%, approximately ±8%, approximately =9%, or approximately ±10% of the numerical values described in the specification.

In addition, descriptions regarding one aspect of the present invention may be equally or similarly applied to identical or similar configurations or terms in descriptions regarding other aspects.

Unless otherwise defined, all terms used herein, including technical or scientific terms, have the same meaning as commonly understood by one of ordinary skill in the art to which the present invention pertains. Terms defined in commonly used dictionaries should be interpreted as having meanings consistent with the meanings they have in the context of the relevant technology, and should not be interpreted in an idealized or overly formal sense unless explicitly defined in the present application.

The polymeric elastomer material according to an embodiment of the present invention may comprise a cross-linked polymer chain; a cationic functional group branched from the polymer chain; and an anionic functional group that is ionically bonded to the cationic functional group and branched from the polymer chain.

In the context of the present specification, the term “polymeric elastomer material” refers to a polymer-based material having the physical property of being able to return to its original form even when stretched or deformed by external stress. Such a material is based on mechanical flexibility and durability, and may include a structure capable of performing electrochemical functions by incorporating ion-conductive pathways therein.

In the context of the present specification, the term “cross-linking” refers to a phenomenon in which two or more polymer chains are interconnected through chemical reactions such as covalent bonding or radical polymerization to form a three-dimensional network structure. This cross-linking plays an important role in forming a structurally continuous solid beyond a simple mixed state, and may contribute to physical strength, thermal stability, and structural integrity.

In the context of the present specification, the term “polymer chain” refers to a linear or branched structure formed by repetitive bonding of monomers. Such a chain serves as a structural backbone that determines the fundamental material properties, and may function as part of the overall network in combination with ionic bonding functional groups or cross-linking groups.

In one embodiment, the cross-linked polymer chain may comprise a poly acrylate-based chain. The concept encompassed by a poly acrylate-based chain refers to a polymer structure formed by connecting monomers having acrylate groups through chemical reactions such as free radical polymerization. This chain fundamentally comprises ester bonds, and has the advantage of enabling the design of various compositions in terms of structural flexibility and polymerization reactivity.

In the context of the present specification, the term “branched from a polymer chain” refers to a chemical linkage formed by functional groups or molecular structures attached in the form of covalent bonds to the main polymer chain extending therefrom. Such a branched structure is not a simple terminal substitution, but rather a form in which functional groups are derived from specific positions along the polymer chain, and in the present invention, cationic or anionic functional groups may be introduced in this manner.

In the context of the present specification, the term “ionic functional group” refers to a functional group or structural unit within a molecule that can carry a positive or negative charge, and serves to induce interactions between polymers through ionic bond formation or to enable electrochemical reactions with external ions. In the present invention, imidazolium-based cations and sulfonate-based anions may be used as representative ionic functional groups.

In one embodiment, the cationic functional group may comprise an imidazolium-based cation. The concept encompassed by an imidazolium-based cation refers to an ionic compound having a positive charge in the form of an imidazole ring with a five-membered ring structure substituted with an alkyl group, and generally has a structure exhibiting high ionic stability and electrochemical properties. The portion bonded to the nitrogen atom may also be substituted with an alkyl group or the like. This structure has a stable electron density distribution, facilitating the formation of ionic bonds with various anions, and when bonded to a polymer chain, may contribute to the construction of an ionic bonding network.

In one embodiment, the imidazolium-based cation may be derived from AEBI (1-(2-Acryloyloxyethyl)-3-butylimidazolium). The advantage of AEBI lies in the fact that a polymerizable acrylate group is introduced into the imidazolium ring, enabling radical polymerization together with other acrylate-based monomers and cross-linking agents. This allows ionic functional groups to be stably introduced into the polymer chain, and even after polymerization, the positive charge state is maintained, inducing the formation of ionic bonds with anionic functional groups. In addition, a medium-length alkyl chain such as a butyl group can provide a certain spacing and flexibility in the organization of the ionic domain, contributing to the regulation of the fluidity and mechanical properties of the overall polymer network.

In one embodiment, the anionic functional group may comprise a sulfonate-based anion. The concept encompassed by a sulfonate-based anion refers to an anionic chemical structure based on a sulfonate functional group having a negative charge in the form of SO₃⁻, which is physically stable and has the property of forming ionic bonds with various cationic structures. Such sulfonate-based anions, owing to their high water solubility and ionic dissociation, may contribute to the formation of stable ion transport pathways within polymer electrolyte systems.

In one embodiment, the sulfonate-based anion may be derived from SPA (3-Sulfopropyl Acrylate). The advantage of SPA lies in the fact that it comprises a sulfonate anion while also having an acrylate group at the terminal end, allowing it to be easily introduced into the polymer network through radical polymerization. Such a structure may be advantageous not only in terms of polymerization reactivity but also in terms of functional dispersibility and bonding stability.

In one embodiment, the polymer chain may be further cross-linked with PEGDA (Poly (ethylene glycol) diacrylate). Additional cross-linking through PEGDA enables the formation of a more elaborate three-dimensional structure within the polymer network, thereby improving structural stability and mechanical durability. PEGDA has acrylate groups at both terminal ends, and by participating in radical polymerization together with ionic dimer-based monomers, it can form connections between different chains. Furthermore, the flexibility and hydrophilicity of the PEG chain itself may have a positive effect on the elasticity and ion mobility of the overall polymer, thereby realizing a well-balanced elastomer structure that maintains ionic conductivity while preserving physical robustness.

In one embodiment, the polymeric elastomer material may further comprise mobile lithium (Li) cations and TFSI (bis(trifluoromethanesulfonyl)imide) anions therein. The addition of an ionic salt introduces ion carriers that can move freely within the polymer network, which may contribute to improving the ionic conductivity of the overall system. In particular, the TFSI⁻ anion has a large and delocalized charge structure, resulting in weak binding with lithium ions, which may be advantageous in increasing the free ion concentration.

In one embodiment, the polymeric elastomer material may exhibit reversible lithium ion behavior between the anode and the electrolyte of a lithium metal battery. This allows lithium ions to migrate uniformly during the charging and discharging process of the battery, and local concentration differences or electrochemical imbalances at the interface may be alleviated. Such properties may help reduce the likelihood of dendrite formation, and may contribute to ensuring long-term cycling stability and reliability under high-current conditions.

In one embodiment, the polymeric elastomer material may be used as an electrolyte in a lithium metal battery. This creates the possibility of alleviating safety issues such as leakage, flammability, and electrolyte depletion associated with conventional liquid electrolytes, while also contributing to the realization of next-generation energy storage devices such as all-solid-state batteries. In particular, the present material simultaneously possesses high ionic conductivity and mechanical strength, which may serve as a foundation for maintaining stable conductive properties even under physical external forces or repeated charge/discharge processes.

In one embodiment, the polymeric elastomer material may maintain stability for approximately 200 or more cycles during lithium ion deposition/dissolution cycling between the lithium metal electrode and the electrolyte. Due to this effect, the formation of lithium dendrites at the interface may be suppressed even during repeated charge/discharge processes, and deterioration of battery performance such as collapse of the electrode structure or capacity reduction may be delayed. Furthermore, since a stable state can be maintained without physical damage to the electrolyte or deterioration of ionic conductivity even during long-term operation, the material may be advantageously applied in applications simultaneously requiring high energy density and high reliability.

In one embodiment, the polymeric elastomer material may have an ionic conductivity of approximately 0.8 mS cm⁻¹ or more. By having such a high ionic conductivity, efficient ion transport becomes possible even in the solid state, and as the internal resistance of the battery decreases, stable performance can be expected even under fast charging or high-power discharge conditions. Furthermore, when the conductivity is maintained above a certain level, the uniformity of electrochemical reactions is improved, which may contribute to reducing performance variation between cells and enhancing device reliability. Such properties may be particularly useful in devices requiring high-density energy storage in limited spaces or in compact electronic devices.

In one embodiment, the polymeric elastomer material may have a tensile strength of approximately 25 MPa or more. By having such a high tensile strength, the structural stability of the material can be maintained even under external stress or repeated mechanical deformation conditions, and the likelihood of fracture or microcrack formation can be reduced. In particular, this may contribute to extending the service life of the material and maintaining stable physical properties in application environments requiring not only flexibility but also toughness, thereby increasing the potential for use in devices continuously exposed to deformation, such as stretchable electronic devices.

In one embodiment, the polymeric elastomer material may have an adhesion strength of approximately 300 kPa or more with a substrate. By having such a high adhesion strength, the material can be stably fixed on various substrates, and the possibility of maintaining consistent performance without interfacial delamination or deformation even under prolonged use or repeated physical contact conditions arises. In particular, sufficient adhesive force can be exerted even between dissimilar materials such as glass, metal, and plastic, which may help form structural integrity in sensor systems with complex surface structures. Such interfacial stability may also play a significant role in terms of resistance to mechanical fatigue and maintenance of electrical connections.

Meanwhile, the method of manufacturing a polymeric elastomer material with improved mechanical properties and ionic conductivity according to an embodiment of the present invention may comprise: mixing a cationic monomer comprising a polymerizable functional group and a cationic functional group, a counter-anion of the cationic monomer, an anionic monomer comprising a polymerizable functional group and an anionic functional group, and a counter-cation of the anionic monomer; removing a precipitate formed by the counter-anion and the counter-cation; and cross-linking the cationic monomer and the anionic monomer.

In the context of the present specification, the term “counter-ion” refers to an ion that coexists to electrically neutralize a cationic or anionic functional group. For example, an imidazolium-based cation generally corresponds to an anion such as bromine (Br⁻), and a sulfonate-based anion may correspond to a cation such as potassium (K⁺). Such counter-ions do not directly participate in the formation of the polymer network, and may act as interfering factors in the reaction between monomers intended to form ionic bonds. Therefore, by selectively removing them, conditions can be established that effectively induce bonding between the desired ionic functional groups.

The role of the mixing step is to bring the cationic monomer and anionic monomer into contact in a chemically reactive state, thereby preparing the basic composition for forming ionic dimers. In this step, an environment is provided in which the counter-ions contained in each monomer can form a precipitate through mutual reaction, contributing to establishing the conditions under which precursors capable of ionic bonding can be generated. Factors such as mixing ratio, temperature, and solvent may affect the reaction efficiency, which may in turn affect the reactivity of subsequent steps and the structural properties of the final polymer.

The role of the precipitate removal step is to remove unnecessary byproducts generated by the mixing of the cationic and anionic monomers, namely the inorganic salt precipitate formed when the counter-ions meet. Such precipitates are primarily generated in the form of ionic salts such as KBr and NaBr, and if left unreacted, may interfere with ionic bond formation within the polymer network or cause deterioration of electrical and mechanical properties. Therefore, by selectively retaining only the reactive ion pairs through the precipitate removal step, conditions can be established to simultaneously secure the structural integrity and ionic conductivity of the polymer.

The role of the cross-linking step is to induce chemical connections between polymer chains based on the ionic dimer structure formed by the cationic and anionic monomers, ultimately forming a continuous three-dimensional network. In this step, UV photopolymerization or chemical cross-linking reactions may generally be utilized, and the density or flexibility of the network can be controlled by using a bifunctional cross-linking agent such as PEGDA.

In one embodiment, the counter-anion may comprise Br⁻ and the counter-cation may comprise K⁺. When the cationic monomer and anionic monomer are mixed, an inorganic salt with relatively low solubility, such as KBr, may be formed in precipitate form through the reaction between Br⁻ and K⁺. This precipitate can be easily separated from the solution, helping to prevent unnecessary ionic byproducts from remaining in the reaction mixture. As a result, a relatively pure ionic dimer state can be maintained, which may be advantageous in inducing efficient formation of inter-ionic bonds in the subsequent cross-linking step.

In one embodiment, the cationic monomer may comprise AEBI (1-(2-Acryloyloxyethyl)-3-butylimidazolium). In one embodiment, the anionic monomer may comprise SPA (3-Sulfopropyl Acrylate).

In one embodiment, the cross-linking may comprise cross-linking by UV photopolymerization or chemical cross-linking. UV photopolymerization refers to a process in which a photoinitiator is activated by ultraviolet (UV) irradiation to form radicals, which then react with polymerizable functional groups such as acrylate groups to form bonds between polymer chains. Chemical cross-linking refers to a process of connecting polymer chains through covalent bonding between chemically reactive functional groups without external stimuli, and is generally carried out by the addition of heat, a catalyst, or a cross-linking agent. Non-limiting examples of other cross-linking methods may include electron beam irradiation, thermal cross-linking, ion exchange-based cross-linking, and self-assembly-based cross-linking after polymer blending.

In one embodiment, the method may further comprise adding LiTFSI (Lithium bis(trifluoromethanesulfonyl)imide) salt prior to the cross-linking. The addition of LiTFSI salt may introduce mobile lithium ions (Li⁺) and electrically stable TFSI⁻ anions into the polymer network, which may help improve the performance of the polymer system as an electrolyte. LiTFSI has a high degree of ionic dissociation even in the solid state, which can increase the ion concentration, and may contribute to forming transport pathways for lithium ions through interaction with PEG-based chains.

In one embodiment, the method may further comprise further cross-linking the cationic monomer and the anionic monomer with PEGDA (Poly (ethylene glycol) diacrylate). The role of this additional cross-linking step is to increase the bonding density between polymer chains and to reinforce the mechanical stability and structural integrity of the overall network structure. PEGDA comprises reactive acrylate groups at both terminal ends, allowing it to readily act as a cross-linking point through radical polymerization, resulting in the formation of a more elaborate and robust three-dimensional network. Furthermore, the flexibility and hydrophilicity of the PEG chain may also contribute to maintaining or improving the ionic conductivity of the polymer matrix.

Hereinafter, embodiments of the present invention are described. However, the embodiments described below are merely some embodiments of the present invention, and the scope of the present invention is not limited to the following embodiments.

### 1. SUMMARY OF EMBODIMENTS

The development of ionic materials with high ionic conductivity and mechanical strength is a challenging task. The present invention presents a novel synthetic strategy for developing a mechanically robust and ionically conductive polyampholyte elastomer based on ionic dimers (IDs) with strong ionic bonds between imidazolium and sulfonate groups. By polymerizing ID monomers with a network capable of forming a cross-linked structure, a novel polyampholyte ID elastomer (IDE) can be fabricated. When lithium (Li) salts are added to the IDE, the ionic conductivity is substantially enhanced up to 0.82 mS cm⁻¹, and the lithium ion transference number (tLi⁺) reaches 0.79. The IDE with Li salts also exhibits excellent mechanical properties, with a tensile strength of 27.4 MPa and a Young's modulus of 211 MPa, outperforming previous polyampholyte elastomers. A resistive-type iontronic sensor using the IDE of the present inventors demonstrates excellent sensitivity (gauge factor=2.92) and reliable cycling performance over approximately 400 cycles under repetitive stress. Furthermore, the IDE serves as a polymer electrolyte in a pouch-type full cell, maintaining stable capacity at a high current density of 1.0 C (corresponding to 4.0 mA cm⁻²) under ambient conditions (25 °C, 0.2 MPa). This synthetic strategy offers a new approach for designing ionic materials that simultaneously achieve high ionic conductivity and mechanical strength.

### 2. RESULTS AND DISCUSSION

### [2.1. Physical Properties of Ionic Dimers (IDs) and Ionic Dimer Elastomers (IDEs)]

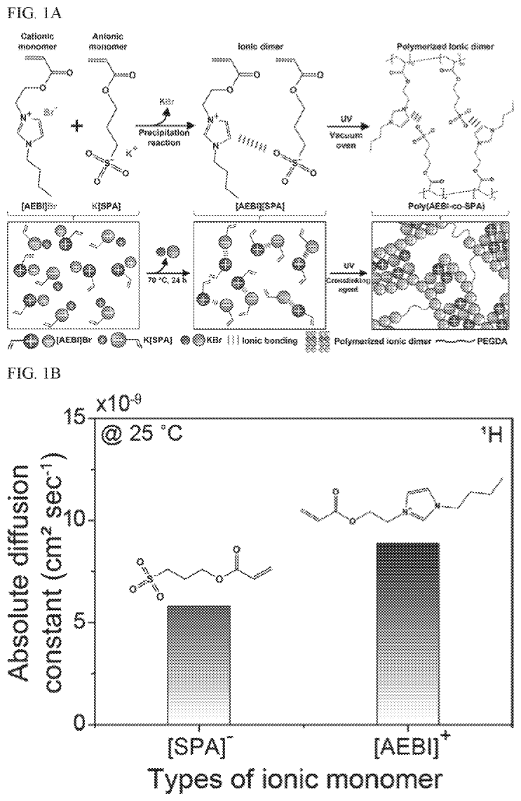

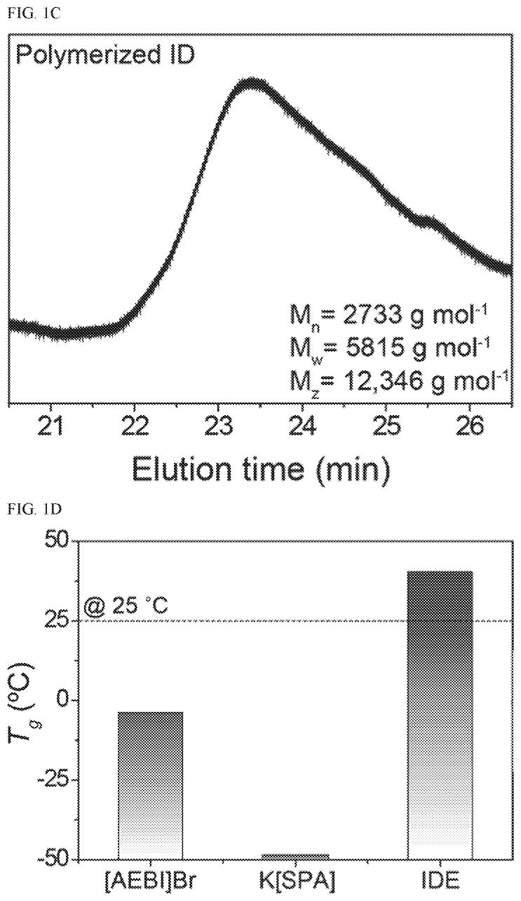

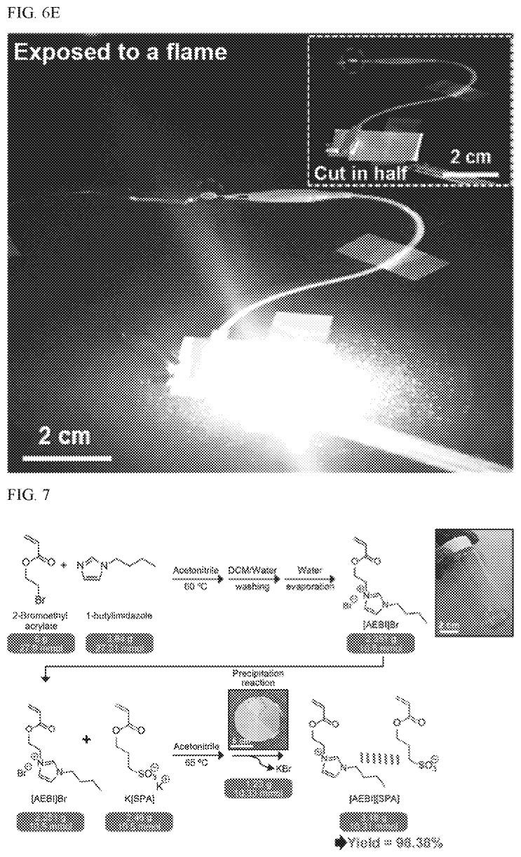

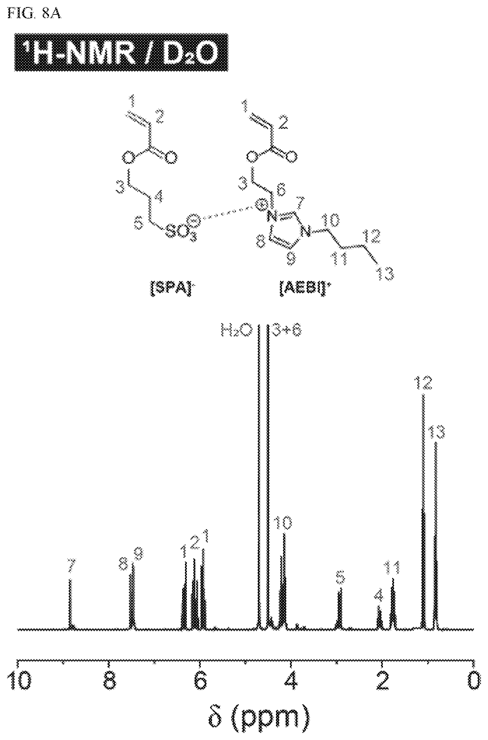

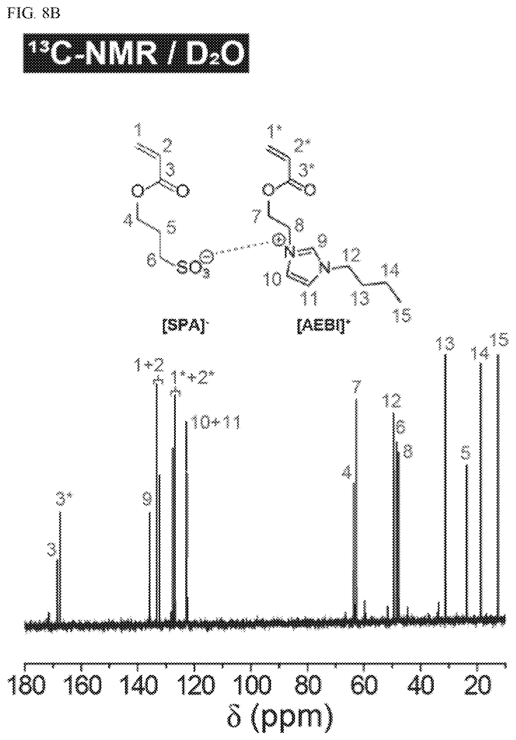

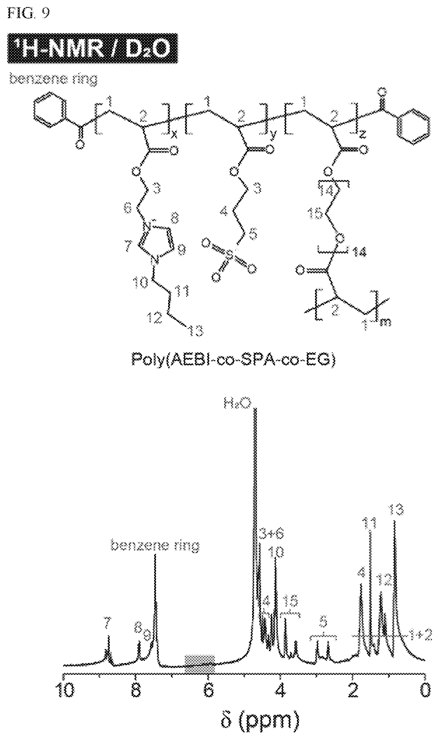

To synthesize an ionic bond-based dimer in the monomeric state, cationic and anionic monomers were mixed and counter-ions were removed through a precipitation reaction (FIG. 1A). As shown in FIG. 7, the KBr precipitate salt generated from the mixture of the cationic monomer (1-[2-acryloyloxyethyl]-3-butylimidazolium bromide, [AEBI]Br) and the anionic monomer (3-sulfopropyl acrylate potassium salt, K[SPA]) was effectively removed (approximately 99%) because acetonitrile is a poor solvent for KBr salt, resulting in a high-purity product (yield=98.38%). As shown in FIGS. 8A and 8B, the chemical structure of the synthesized ionic dimer (ID) was characterized by ¹H nuclear magnetic resonance spectroscopy (¹H NMR) and ¹³C nuclear magnetic resonance spectroscopy (¹³C NMR). The synthesized ID was then fabricated into an ionic dimer elastomer (IDE) through a copolymerization reaction involving mixing a photoinitiator and a chemical cross-linking agent (FIG. 1A). Polymerization from ID to IDE was confirmed by the disappearance of the peak associated with the acrylate group in ¹H NMR (FIG. 9).

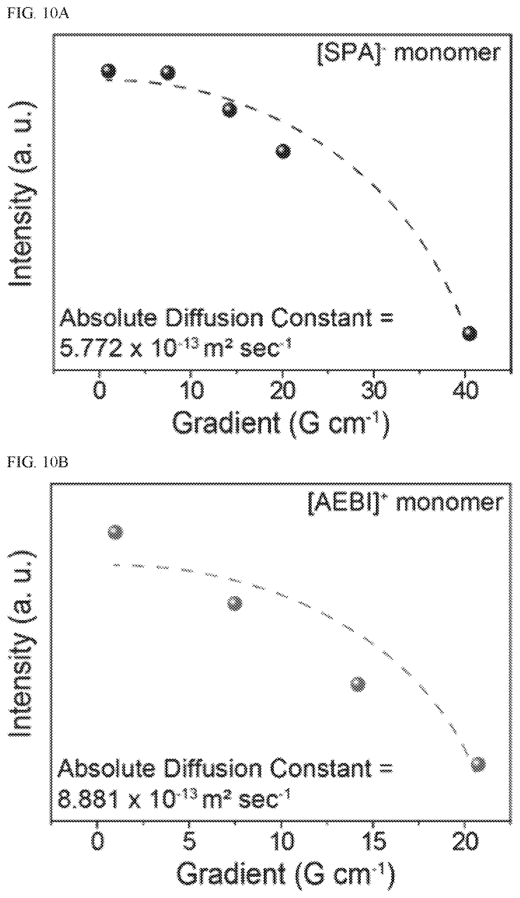

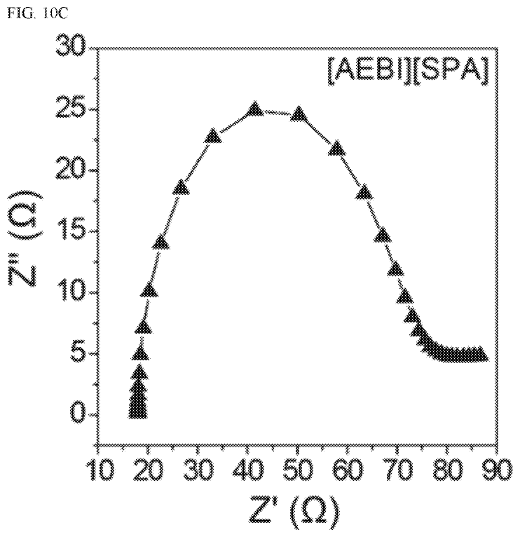

In FIG. 1B, the ionic dissociation constant (ξ) of the synthesized ID was calculated to be 0.0035. The & value can be determined using electrochemical impedance spectroscopy (EIS) and pulse field gradient nuclear magnetic resonance (PFG-NMR). First, ξ is estimated using the ionic conductivity (λEIS) measured by EIS and the molar conductivity (ΛNE) obtained from PFG-NMR. EIS is a fast experimental method for measuring the ionic conductivity of a system, and the conductivity measured using this method includes only the conductivity contributed by “free ions.” In contrast, PFG-NMR measures the average self-diffusion coefficients (D₊ and D₋) of ions without distinguishing ion pairing or aggregation, which is used to calculate the molar conductivity (ΛNE). In this case, λEIS was measured to be 0.0549 mS cm⁻¹, and the molar concentration of ID per unit volume (CIL) was 0.95×10⁻³ mol cm⁻³. The ΛNE calculated using the Nernst-Einstein equation was 6.39×10³⁴ e² s kg⁻¹ mol⁻¹, and the resulting & value was calculated to be 0.0035 (FIG. 10C and Table 2). Such a very low & value indicates a strong ionic bonding state at room temperature, confirming that a low & corresponds to strong ionic bonding.

To analyze the degree of polymerization when ID was polymerized without a chemical cross-linking agent (poly (ethylene glycol) diacrylate, PEGDA), the molecular weight and polymer dispersity index (PDI) were measured using gel permeation chromatography (GPC) (FIG. 1C). The number-average molecular weight (Mn), weight-average molecular weight (Mw), and z-average molecular weight (Mz) of the ID sample polymerized without a chemical cross-linking agent were measured to be approximately 2733, 5815, and 12346 g mol⁻¹, respectively, and the PDI was confirmed to be 2.127.

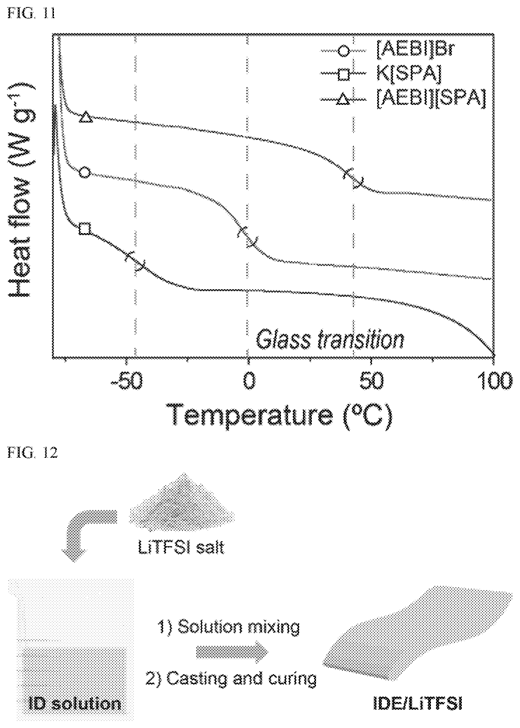

As shown in FIGS. 1D and 11, the glass transition temperatures (Tg) of the gels polymerized from [AEBI]Br and K[SPA], respectively, using PEGDA were measured by differential scanning calorimetry (DSC) and found to be 1 °C and −48 °C, respectively. In contrast, the Tg of the IDE polymerized using PEGDA was measured to be 47 °C. The reason why the Tg of the IDE is higher than the intermediate value between the [AEBI]Br gel and the K[SPA] gel is interpreted to be due to the restricted mobility of the polymer chains caused by strong ionic bonding within the IDE.

### [2.2. Ion Transport Properties of IDE]

As shown in FIG. 12, IDE/LiTFSI was synthesized by introducing LiTFSI salt into an ID solution containing PEGDA, a photoinitiator, and a solvent, followed by analysis of its thermal and physical properties. The LiTFSI salt was introduced based on the molar ratio of ID, and the molar ratio of LiTFSI (Y mol) to ID (X mol) is expressed as IDE/LiTFSI_X/Y (mol/mol) (see Table 1).

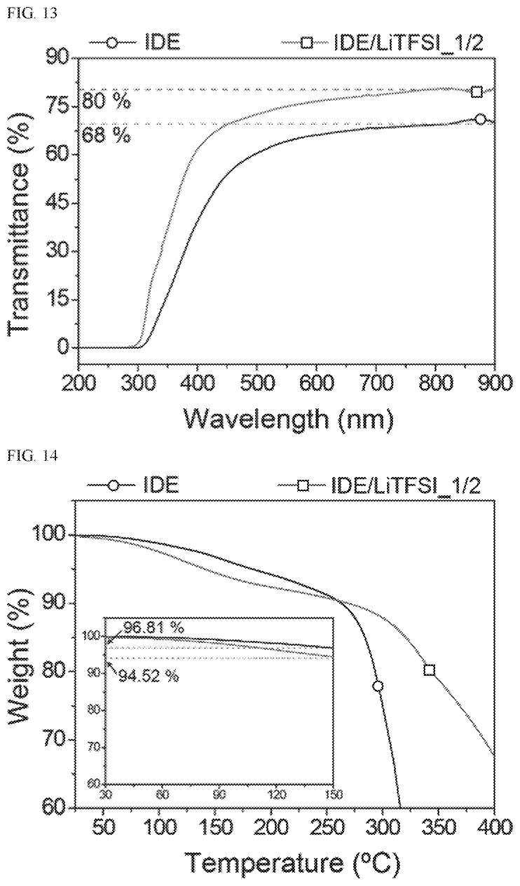

As shown in FIG. 13, the IDE sample exhibits a transmittance of approximately 68%, which is attributed to ionic bonding within the amorphous structure. The IDE/LiTFSI_1/2 sample exhibits a transmittance of approximately 80%, and the thickness of both samples is 500 micrometers. The thermal stability of IDE and IDE/LiTFSI_1/2 was evaluated in ethanol by thermogravimetric analysis (TGA) under a nitrogen atmosphere in the range of 30-400 °C, revealing decomposition temperatures of approximately 275 °C and 310 °C, respectively, with residual solvent content maintained at approximately 5% up to 150 °C (FIG. 14).

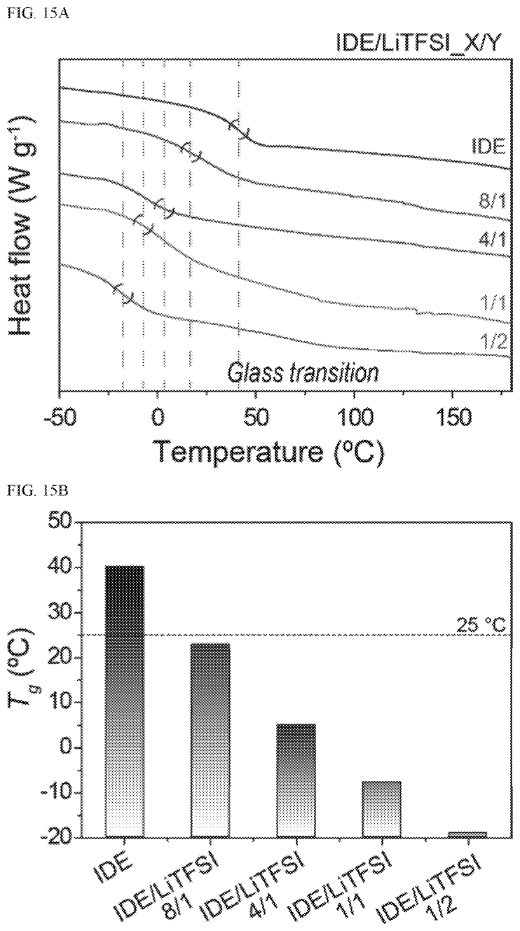

DSC analysis was further performed to investigate the glass transition temperatures (Tg) of IDE and IDE/LiTFSI_X/Y. As shown in FIGS. 15A and 15B, IDE has a Tg of 47 °C, which is attributed to strong ionic bonding within the polymer matrix (see FIG. 1D). As the LiTFSI concentration increases, the plasticization effect of the salt increases the flexibility of the polymer chains, and accordingly, the Tg shows a tendency to decrease gradually. Specifically, the Tg values of IDE/LiTFSI_X/Y decrease to 23 °C, 5 °C, −7 °C, and −19 °C, respectively, with increasing LiTFSI concentration.

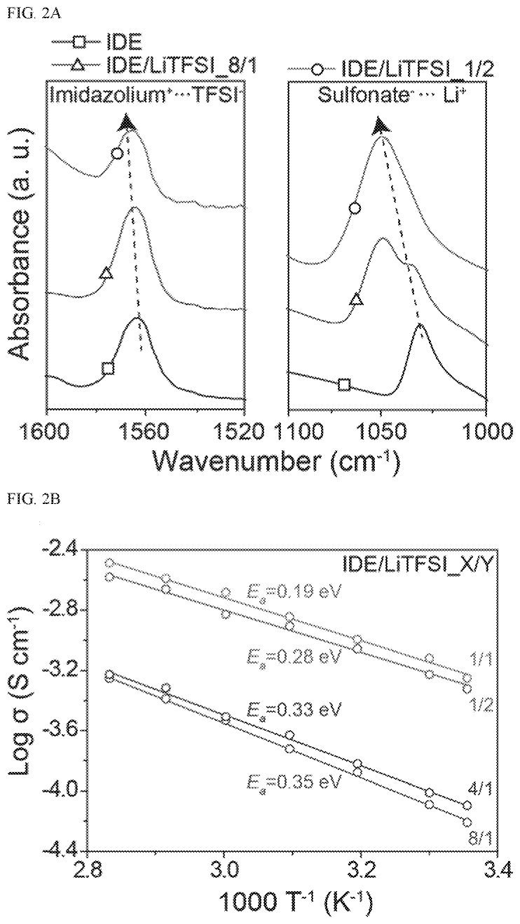

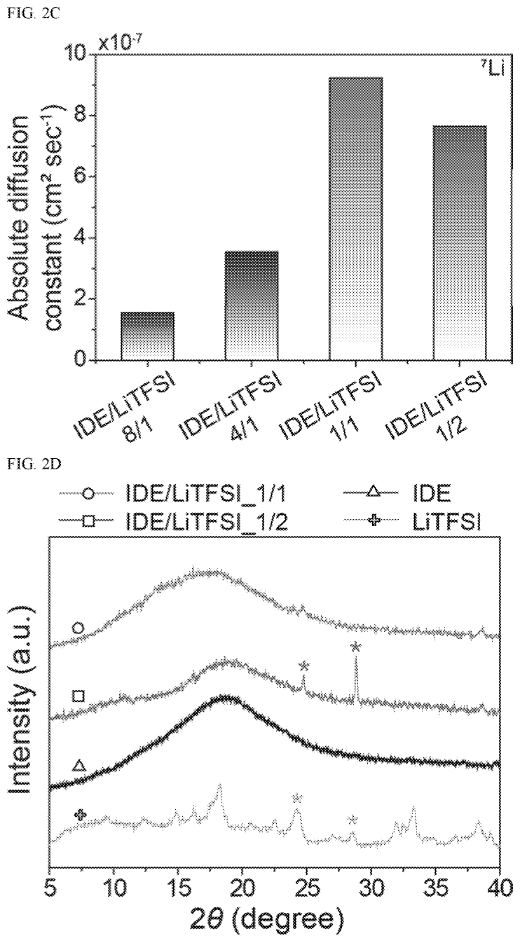

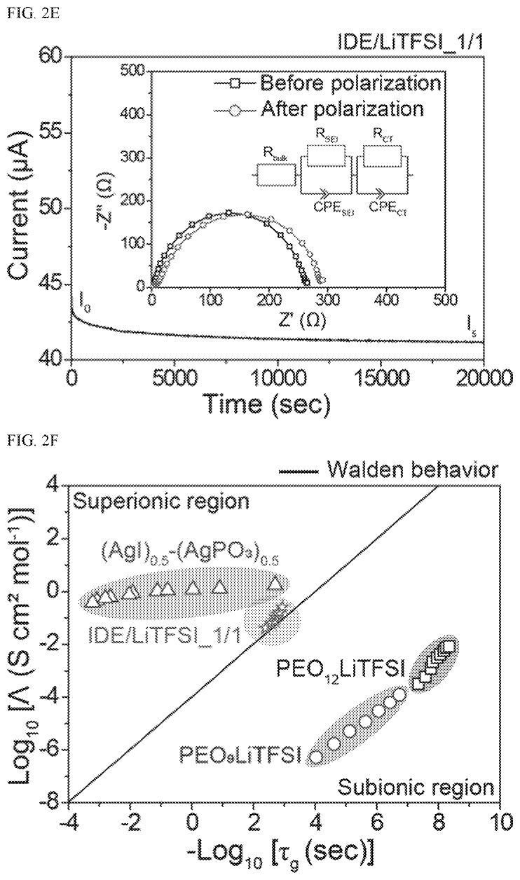

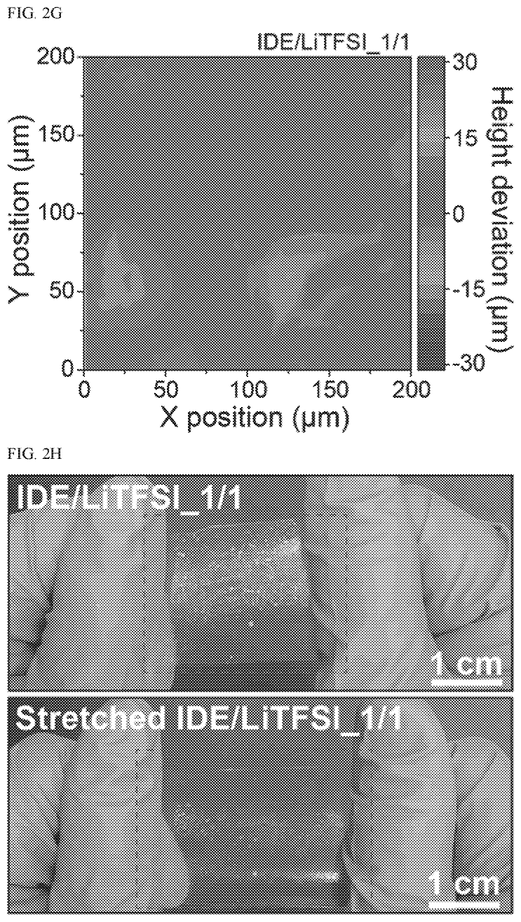

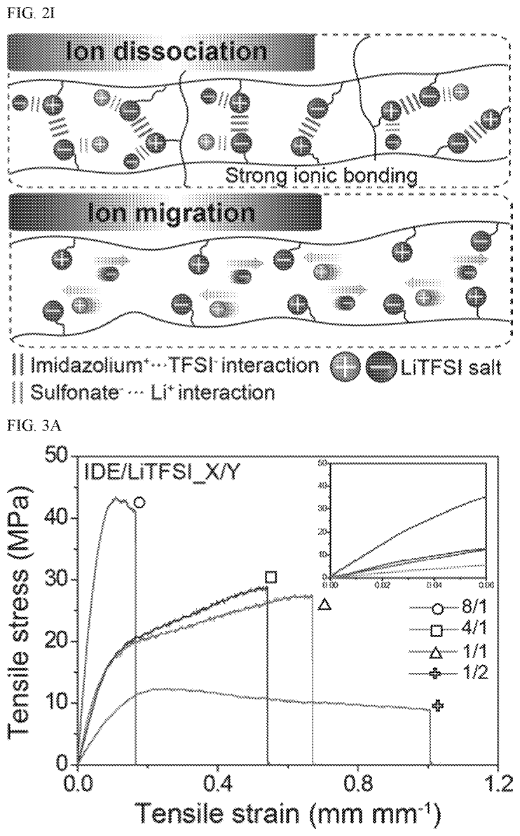

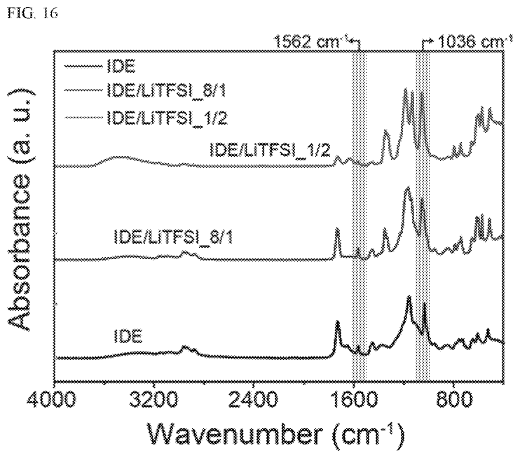

ATR FT-IR (attenuated total reflectance Fourier transform infrared spectroscopy) analysis was performed to analyze the physicochemical interactions between the constituent components formed by introducing LiTFSI into the IDE. As shown in FIG. 2A, the imidazole stretching vibration and sulfonate symmetric stretching vibration peaks of IDE appear at 1564 cm⁻¹ and 10³⁴ cm⁻¹, respectively (FIG. 16). As the LiTFSI concentration increases, these peaks shift toward higher wavenumbers (blue shift), indicating strong interactions between imidazole . . . TFSI⁻ and sulfonate . . . Li⁺. This pronounced interaction is attributed to (i) the high ionic dissociation efficiency of LiTFSI and (ii) the enhancement of Li⁺ transport through interaction with TFSI⁻.

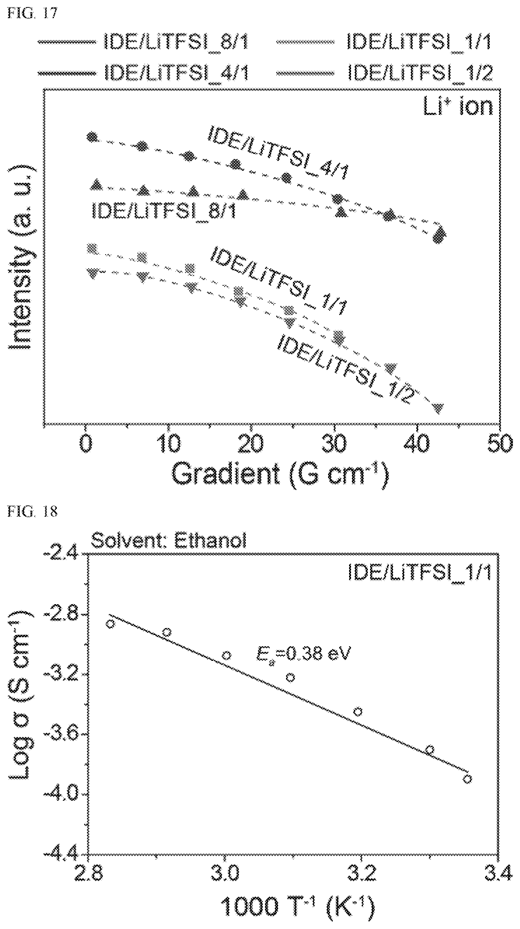

The ionic conductivity of IDE/LiTFSI_X/Y was measured to be 0.059, 0.076, 0.820, and 0.480 mS cm⁻¹, respectively, with increasing LiTFSI content (FIG. 2B). A decrease in conductivity was observed for IDE/LiTFSI_1/2. The relationship between LiTFSI concentration and the self-diffusion coefficient of Li⁺ was analyzed by PFG-NMR measurements (FIGS. 2C and 17), and the self-diffusion coefficients of IDE/LiTFSI_X/Y were found to be 1.548, 3.540, 9.232, and 7.655 cm² s⁻¹, respectively, consistent with the ionic conductivity trend in FIG. 2C. However, in IDE/LiTFSI_1/2, the excessive LiTFSI content relative to the polymer chains was found to impede ion transport, leading to a lower Li⁺ diffusion coefficient and decreased conductivity. These results suggest that the balance between LiTFSI content and polymer structure is critical for performance optimization.

These results demonstrate that the IDE may play a role in stabilizing the dispersion state of IDE/LiTFSI_1/1. This was further confirmed by X-ray diffraction (XRD) analysis (FIG. 2D): no distinct crystalline peaks were observed in the XRD pattern of IDE/LiTFSI_1/1, whereas peaks corresponding to crystalline LiTFSI domains were observed at 24.68° and 28.53° in IDE/LiTFSI_1/2. These results demonstrate that the optimized IDE structure promotes uniform dispersion and enhanced dissociation of LiTFSI within IDE/LiTFSI_1/1, reinforcing its potential as a high-performance polymer electrolyte.

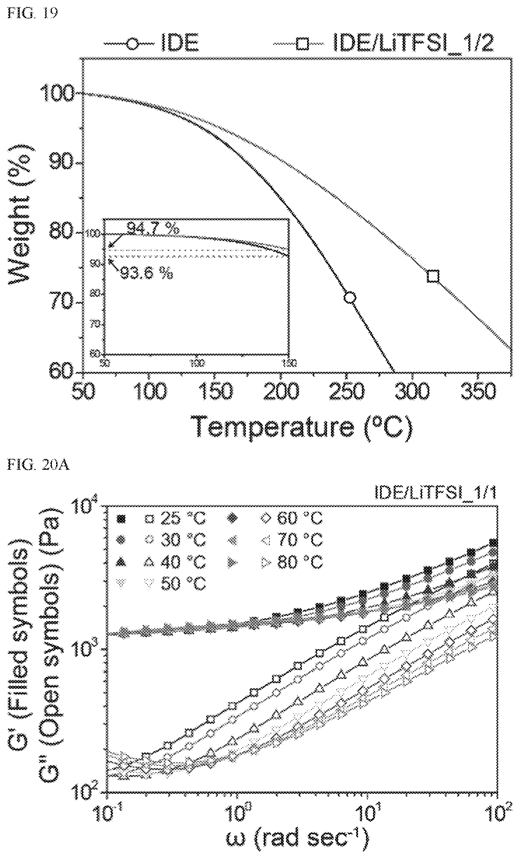

The electrochemical performance of IDE/LiTFSI was evaluated as a polymer electrolyte for all-solid-state battery (ASSB) applications, with particular focus on the correlation between the ionic bond-based polymer chain structure of IDE and its ion transport properties. In addition, dimethylformamide (DMF) was used as an alternative solvent for IDE/LiTFSI to mitigate the electrochemical instability induced by ethanol and reduce reactivity with the Li metal anode. The DMF-based IDE/LiTFSI_1/1 exhibited ionic conductivity similar to that of the ethanol-based IDE/LiTFSI_1/1 (FIG. 18). As shown in FIG. 19, the DMF-based and ethanol-based IDE/LiTFSI also exhibited similar levels of residual solvent content.

The single-ion (Li⁺) conduction properties of IDE/LiTFSI_1/1, which exhibited the highest ionic conductivity (0.820 mS cm⁻¹), were analyzed by measuring/Li⁺ at room temperature using the potentiostatic polarization method. IDE/LiTFSI_1/1 exhibited a high tLi⁺ value of 0.79 (Table 3), indicating the predominant contribution of Lit to the ionic conductivity. In particular, this tLi⁺ value is higher than those of previously reported elastic ionic conductors (FIG. 2E), suggesting that the ionic bonding structure of the IDE and the immobilization effect of TFSI⁻ through the imidazole functional group are the primary contributing factors (see FIG. 2A).

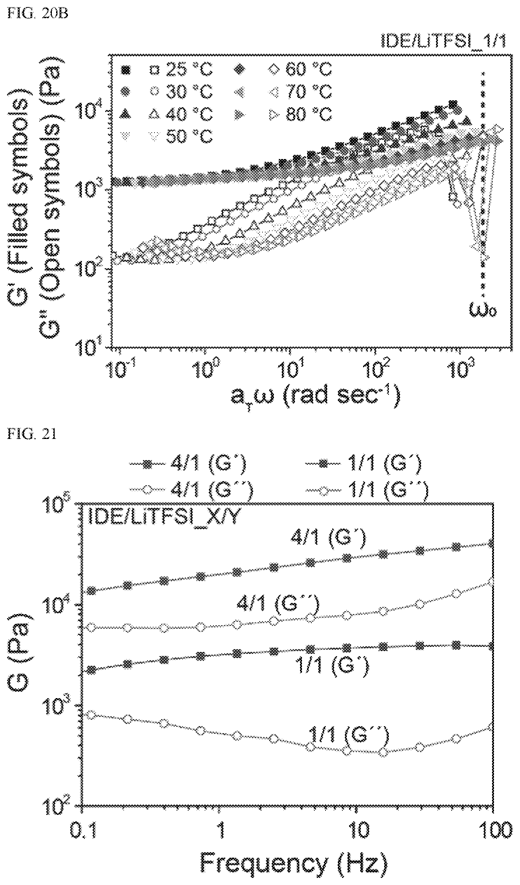

Walden plot analysis (FIG. 2F) was performed to evaluate the effect of the ionic bonding structure on ion transport efficiency, and the relationship between molar conductivity (Λ) and glass relaxation time (τg) was also investigated. The Walden plot of IDE/LiTFSI_1/1 is located above the ideal Walden line, indicating that the ionic bonding structure within the IDE polymer chain enhances ion transport. In particular, IDE/LiTFSI_1/1 exhibits superionic conduction behavior comparable to that of (AgI)_{0.5}—(AgPO₃)_{0.5}, with a τg approximately 100 times faster than that of conventional PEO-based electrolytes at 25 °C. The detailed procedure of the time-temperature superposition method used to extract the τg values is described in FIGS. 20A and 20B. Literature data for PEO₉LiTFSI, PEO₁₂LiTFSI, and the superionic ceramic (AgI)_{0.5}—(AgPO₃)_{0.5} electrolyte were utilized for comparison. These results suggest that ion transport in the IDE is driven by the ionic bonding structure between polymer chains, and is fundamentally different from conventional polymer electrolytes that rely on segmental motion.

Laser scanning confocal microscopy (LSCM) analysis, which enables visualization of surface roughness, was performed to evaluate the effect of the precursor state of IDE/LiTFSI_1/1 on dispersion uniformity. IDE/LiTFSI_1/1 was well dispersed in the precursor state, with negligible height variation even over a wide-area scan region (FIG. 2G). As shown in FIG. 2H, IDE/LiTFSI_1/1 can be processed into a large-area film of 3×5 cm² while retaining its elastic properties, demonstrating high elongation. As shown in FIG. 2I, the ionic bonding structure of the IDE enables high ionic dissociation and efficient ion migration through interaction with LiTFSI, supporting the enhancement of its ion transport properties.

### [2.3. Mechanical Properties of IDE]

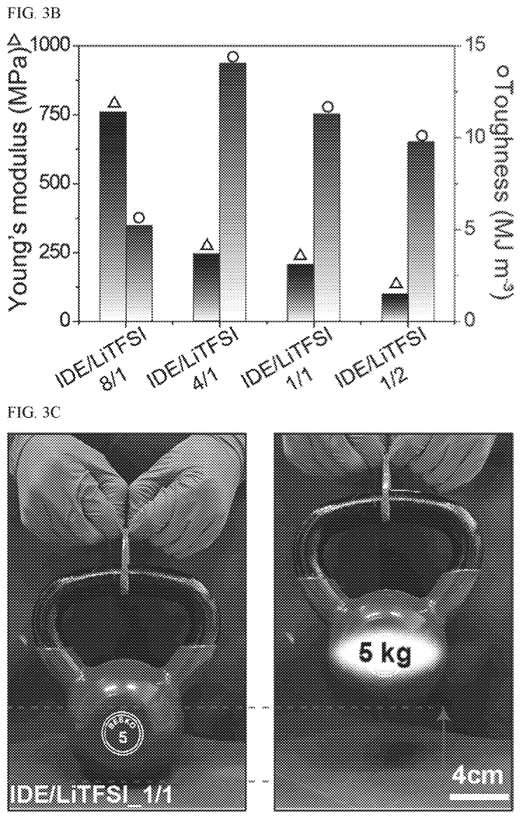

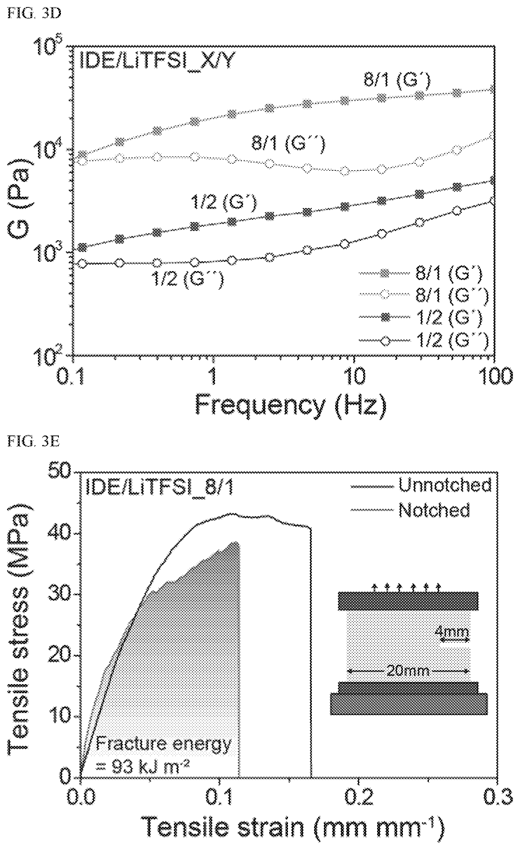

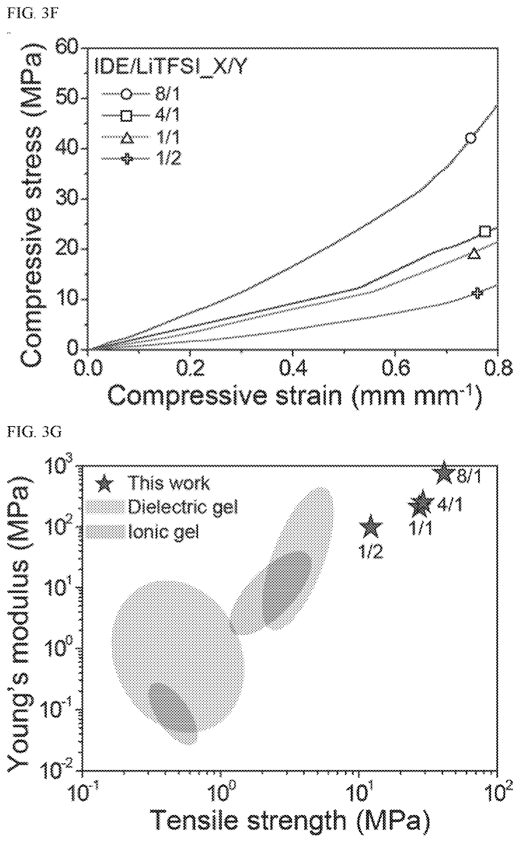

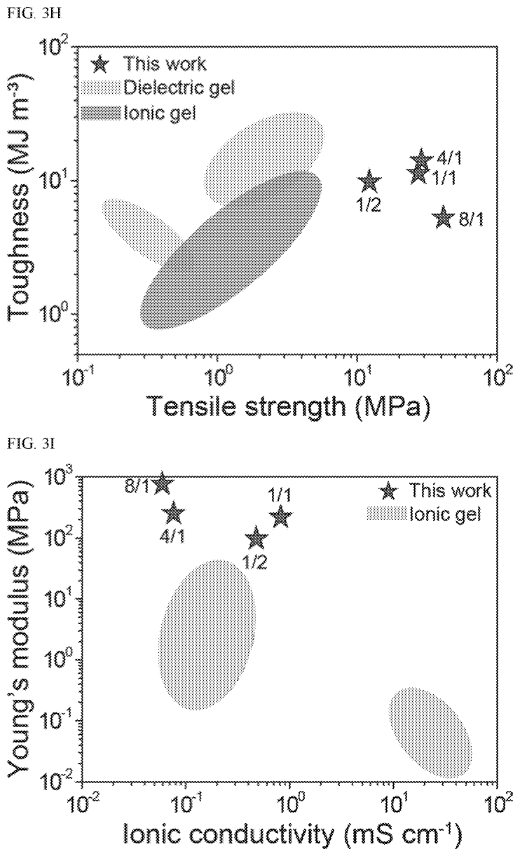

FIGS. 3A through 3I show the results of investigating the effect of the strong ionic bonding structure within the IDE on mechanical properties, and evaluating the mechanical performance as a function of LiTFSI salt content.

As shown in FIG. 3A, as the LiTFSI salt content increased, the tensile strength of IDE/LiTFSI_X/Y decreased to 41, 28, 27, and 12 MPa, respectively, while the elongation at break increased to 16%, 57%, 66%, and 100%, respectively. As the LiTFSI salt content increases, the flexibility of the polymer network improves, resulting in a decrease in mechanical properties. Nevertheless, the strong ionic bonding structure of the IDE contributes to maintaining excellent mechanical properties.

In addition, the Young's modulus of IDE/LiTFSI_X/Y was calculated to be 753, 243, 211, and 99 MPa, respectively, and the toughness was found to be 5, 14, 11, and 9 MJ m⁻³, respectively (FIG. 3B). These results demonstrate that even with the addition of LiTFSI salt, the strong ionic bonding structure within and between the polymer chains of the IDE can be maintained, and that the mechanical strength of IDE/LiTFSI can be tuned accordingly.

FIG. 3C shows IDE/LiTFSI_1/1 demonstrating excellent mechanical properties by lifting a 5 kg weight. FIGS. 3D and 21 show the results of frequency sweep rheology tests measuring the mechanical properties of IDE/LiTFSI_X/Y in the frequency range of 0.1-100 Hz. Within this frequency range, IDE/LiTFSI_X/Y exhibits both storage modulus (G′) and loss modulus (G″), demonstrating that the stable ionic bonding structure is maintained even after the addition of LiTFSI.

The strong ionic bonding between polymer chains imparts IDE with very high resistance to crack propagation, and the ionic bonding structure effectively alleviates stress concentration at crack tips. As shown in FIG. 3E, the notched IDE/LiTFSI_8/1 sample withstands up to 60% of its maximum elongation, demonstrating excellent crack propagation resistance.

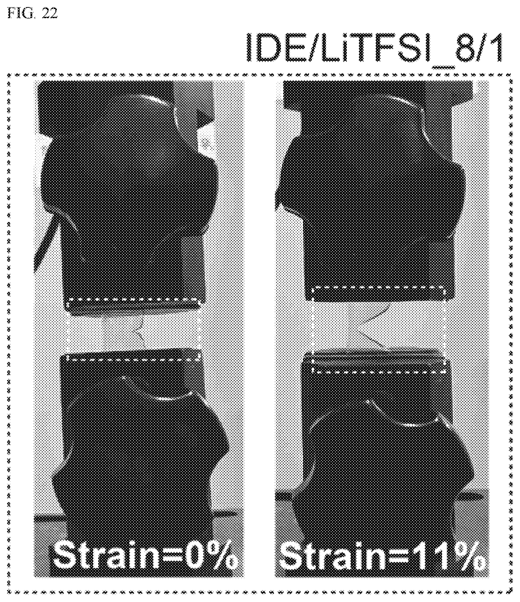

Furthermore, the fracture energy (T) of IDE/LiTFSI_8/1 was measured to be 93 kJ m⁻², which is comparable to values reported for zinc alloys (<100 kJ m⁻²), titanium alloys (<110 kJ m⁻²), and other reported materials. FIG. 22 presents the notched IDE/LiTFSI_8/1 sample, further demonstrating its low sensitivity to crack propagation.

FIG. 3F shows the compressive strength test results of IDE/LiTFSI_X/Y, measured at a maximum compressive strain of 80%. In a trend similar to that of the tensile tests, the compressive strength decreased as the LiTFSI content increased.

FIGS. 2A through 2I and FIGS. 3A through 3I illustrate the correlation between the ionic behavior and mechanical properties of IDE/LiTFSI. The strong ionic bonding structure of the IDE enhances ionic dissociation and mobility while simultaneously contributing to the improvement of mechanical properties by maintaining ionic interactions between polymer chains.

Compared with previous polyampholyte-based studies that sought to simultaneously achieve ionic conductivity and mechanical performance based on dielectric or ionic gels, the present system demonstrates a distinct advantage in terms of both mechanical strength and ionic conductivity (see FIGS. 3G, 3H, and 3I).

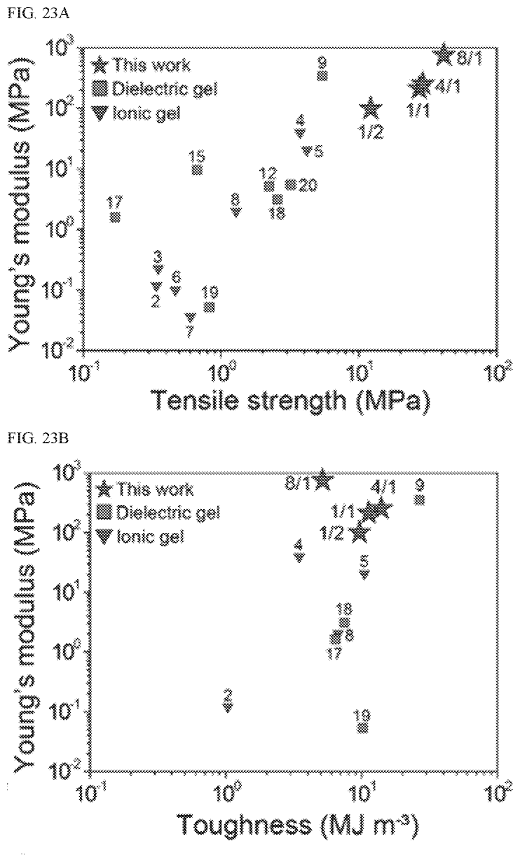

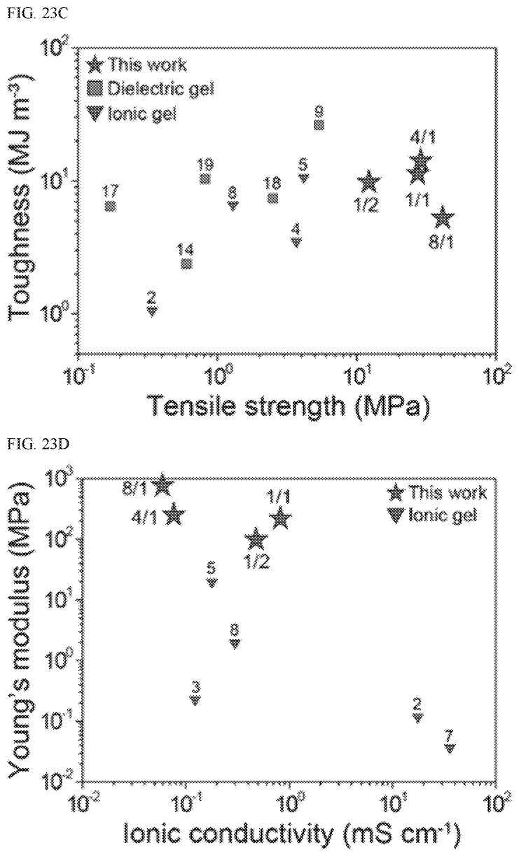

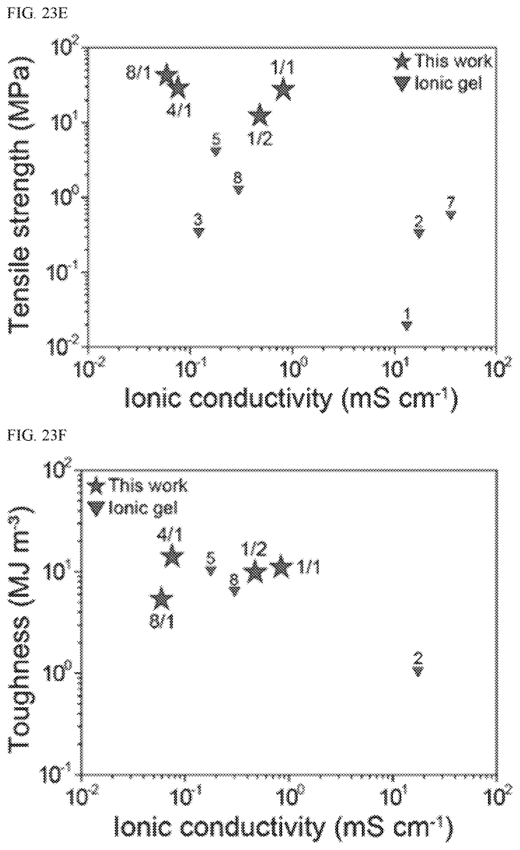

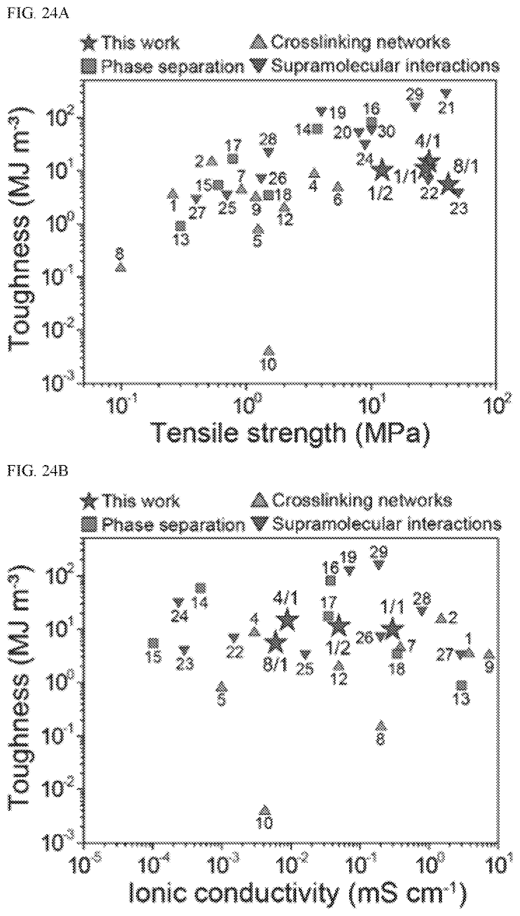

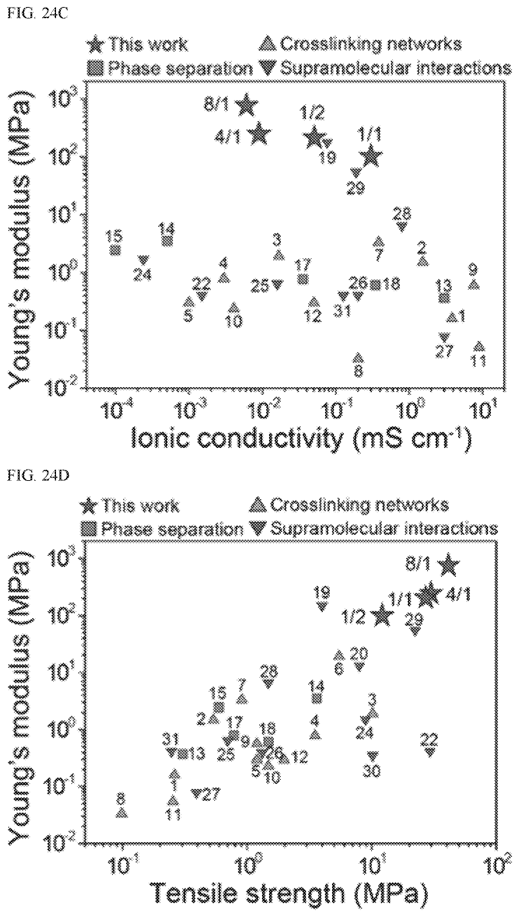

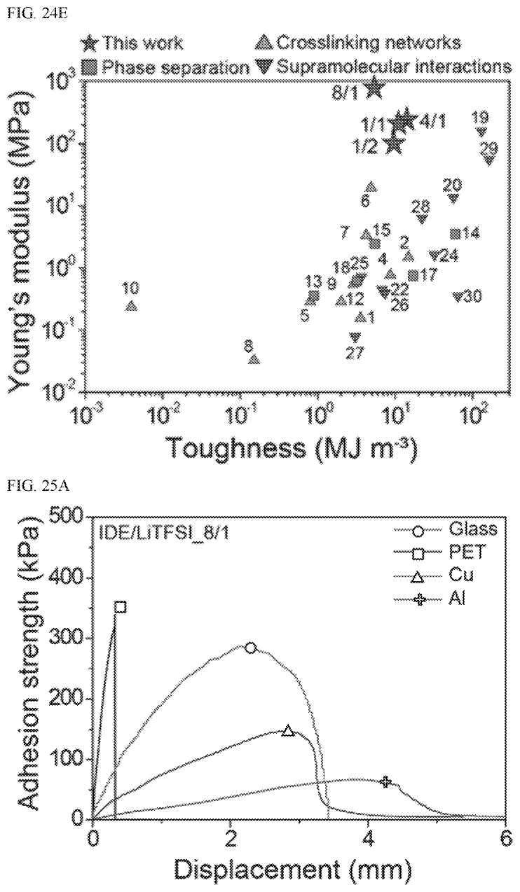

Further details are provided in FIGS. 23A through 23F, where in particular the Young's modulus and ionic conductivity of the polyampholyte exceed previously reported values, once again demonstrating its superiority. Furthermore, IDE/LiTFSI also shows superior performance compared with previously reported high-strength elastomers based on ionic bonding (FIGS. 24A through 24E).

### [2.4. Adhesion Properties of IDE/LiTFSI]

The ionic bonding structure of IDE/LiTFSI_X/Y enables adhesion to various substrates simply by attaching the sample to a substrate to form contact. Strong adhesion to various substrates is a critically important factor for the stability, durability, and development of non-invasive devices in the iontronic field. Furthermore, it is an essential material property for securing electrode adhesion stability and advancing flexible solid-state battery technology in energy storage devices, particularly in battery research.

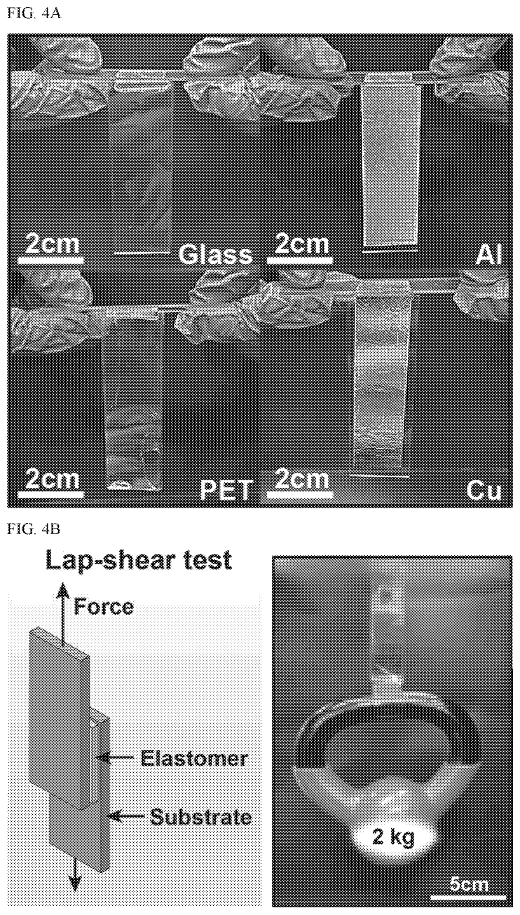

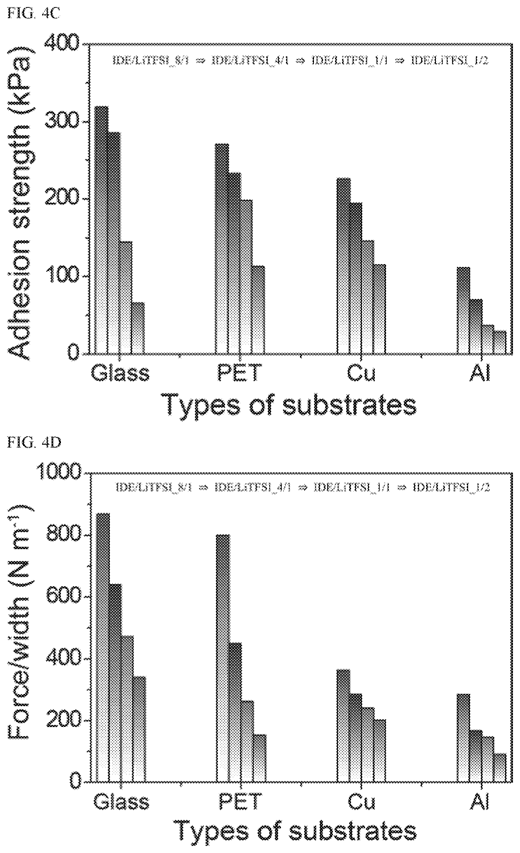

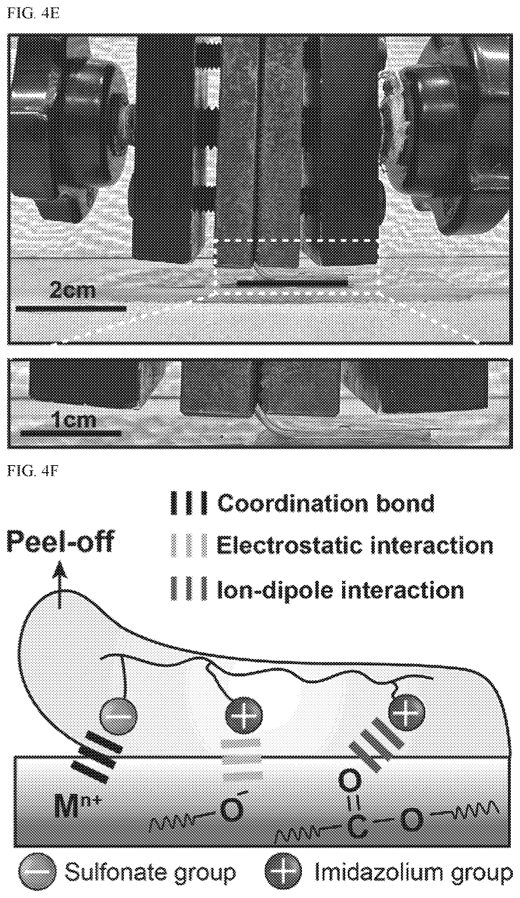

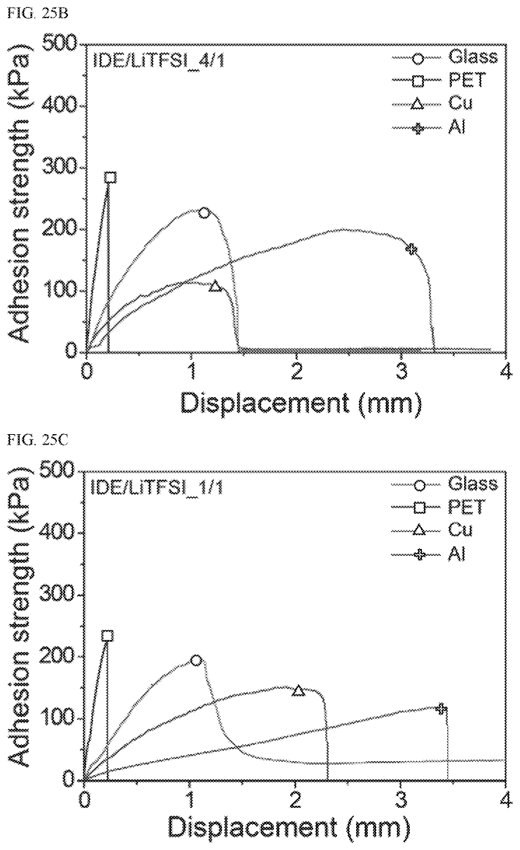

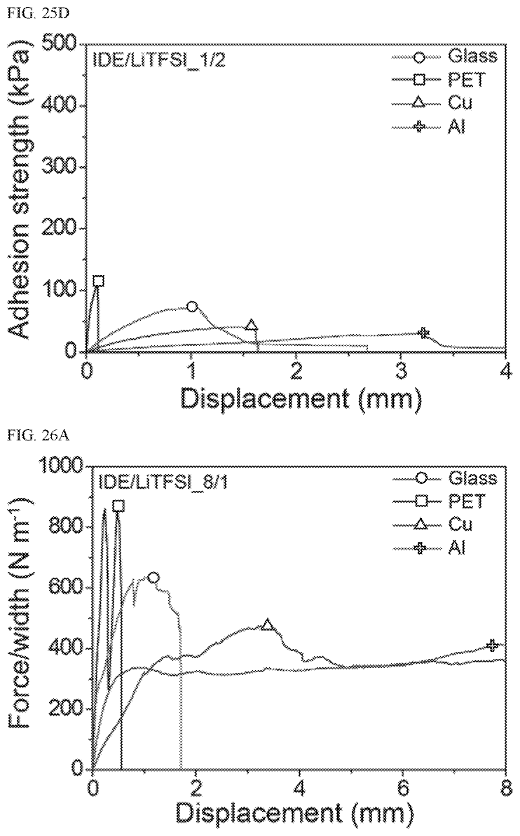

The IDE/LiTFSI_8/1 sample demonstrated strong adhesion to glass, polyethylene terephthalate (PET), copper (Cu), and aluminum (Al) substrates without any additional surface pretreatment or modification (FIG. 4A), and the adhesion strength was evaluated through 180° lap shear tests. To further verify the adhesion performance, IDE/LiTFSI_X/Y samples were tested with various substrates (FIG. 4B and FIGS. 25A through 25D), and the photograph on the right side of the figure shows the IDE/LiTFSI_X/Y sample adhered to a glass substrate supporting a 2 kg weight. FIG. 4C shows the adhesion strength of IDE/LiTFSI_X/Y samples on glass, PET, Cu, and Al substrates, among which the IDE/LiTFSI_8/1 sample exhibited the highest adhesion strength of 320 kPa on the glass substrate.

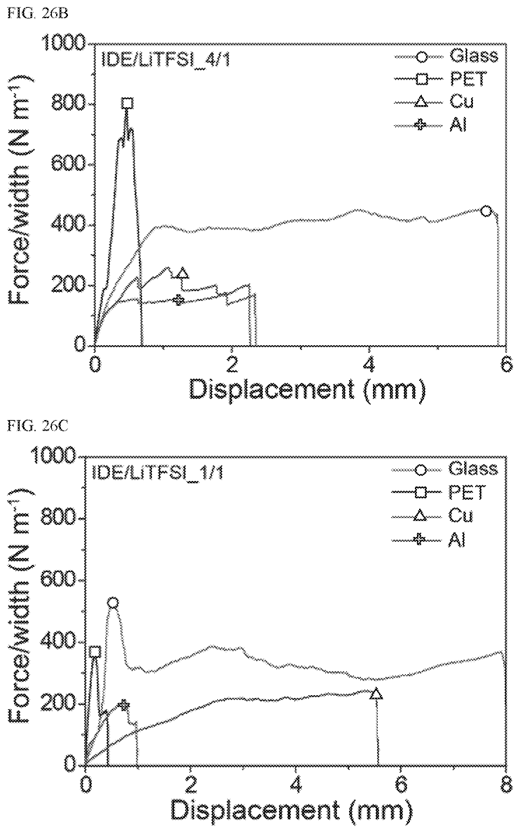

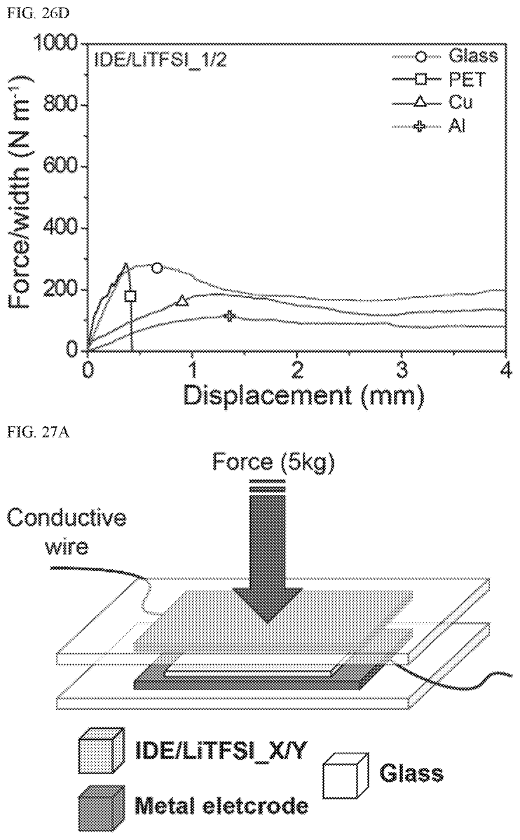

In FIG. 4D, the peel force between IDE/LiTFSI_X/Y samples and various substrates was measured by 90° peel tests (see FIGS. 26A through 26D), and a rigid PET film with a thickness of 300 μm was attached to limit crack tip deformation of the IDE/LiTFSI_X/Y samples. Among the tested combinations, the IDE/LiTFSI_8/1 sample demonstrated excellent adhesion performance on glass, exhibiting a peel force of 300-900 Nm-1. FIG. 4E shows the process of the IDE/LiTFSI_8/1 sample being peeled from the glass substrate. FIG. 4F describes the adhesion mechanism by which IDE interacts with various substrates in three forms: within the IDE, sulfonate groups form coordinate bonds with metal atoms, imidazole groups engage in electrostatic interactions with glass, and ion-dipole interactions occur with PET. Through these interactions, it is confirmed that IDE exhibits strong adhesion properties with various substrates.

[2.5. Iontronic Applications through Mechanical and Resistance Change Properties of IDE/LiTFSI Devices]

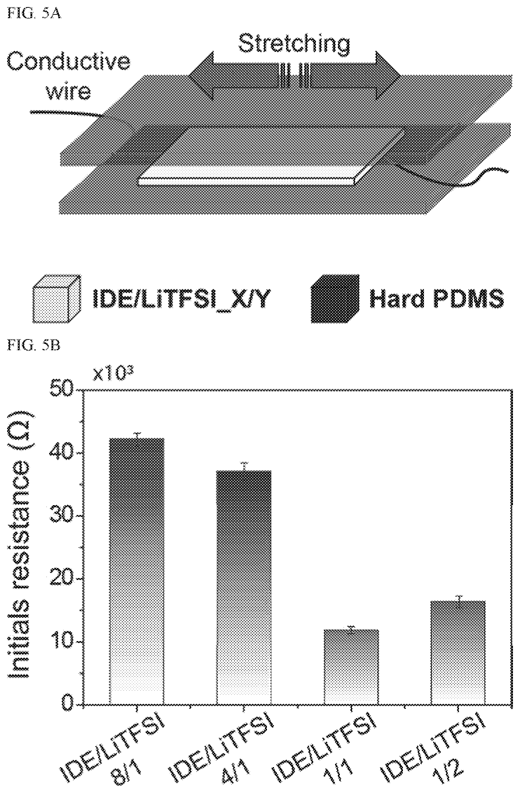

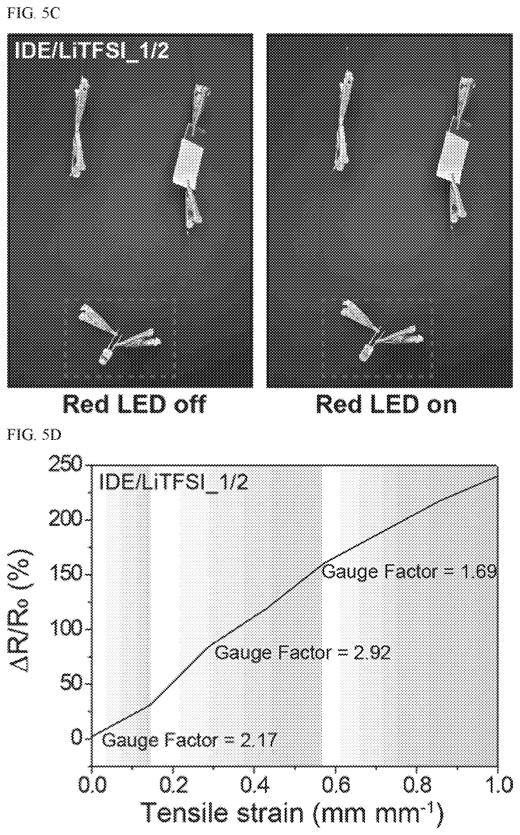

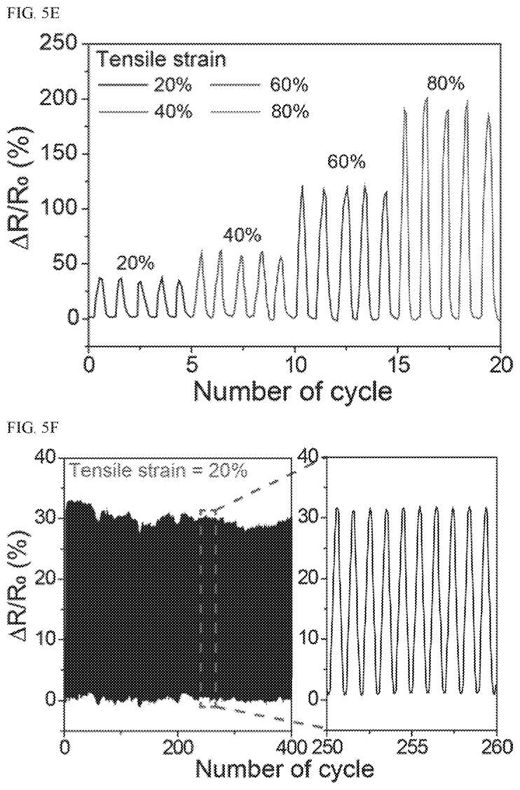

FIG. 5A is a schematic of a resistance-based iontronic sensor using IDE/LiTFSI_X/Y for strain sensing. As shown in FIG. 5B, the resistance of IDE/LiTFSI_X/Y devices follows a trend similar to the ionic conductivity analyzed in FIG. 2C, and the IDE/LiTFSI_1/1 device exhibits the lowest resistance (12 k (2) owing to its excellent ionic conductivity. FIGS. 27A and 27B are schematics for analyzing the stability of resistance-based iontronic sensors by utilizing the load-bearing properties of IDE/LiTFSI_X/Y devices (dimensions: 2.0×1.0×0.1 cm³). When a 5 kg weight was applied on top of the IDE/LiTFSI_X/Y device covered with glass (FIG. 27A), no change in resistance was observed even after 1 hour (FIG. 27B), demonstrating the stability of the resistance-based iontronic sensor.

The IDE/LiTFSI_1/2 device, which has the highest elongation of 100%, is suitable as a resistance-based iontronic sensor, and its strain sensing performance under deformation was investigated. According to FIG. 5C, IDE/LiTFSI_1/2 stably operated a red light-emitting diode (LED) bulb as an ionically conductive material. Furthermore, as IDE/LiTFSI_1/2 was stretched, the cross-sectional area decreased and the resistance increased significantly. The resistance change (ΔR/R₀) of the resistance-based sensor was monitored over a strain range of 0-100%, and the gauge factor (GF), which defines the relative change in resistance as a function of applied strain, can serve as an indicator for evaluating sensor sensitivity. In FIG. 5D, the GF values of IDE/LiTFSI_1/2 were measured to be 2.17 in the strain range of 0-14%, 2.92 in the range of 14-56%, and 1.69 in the range of 56-100%, demonstrating the high sensitivity of the strain sensor fabricated from this material.

Repetitive tensile and relaxation experiments were performed in the 20-80% strain range (FIG. 5E), and the IDE/LiTFSI_1/2 sensor exhibited accurate and reversible resistance response. The sensor also maintained resistance stability after 400 tensile cycles and was capable of sensing stress over a wide range of strains (FIG. 5F). These results demonstrate that IDE/LiTFSI has potential as an ionic conductor through LED operation, and confirm its suitability for stable iontronic applications under real operating conditions, based on its reversible resistance change and stability under mechanical deformation.

[2.6. Application of IDE/LiTFSI to all-Solid-State Batteries (ASSBs)]

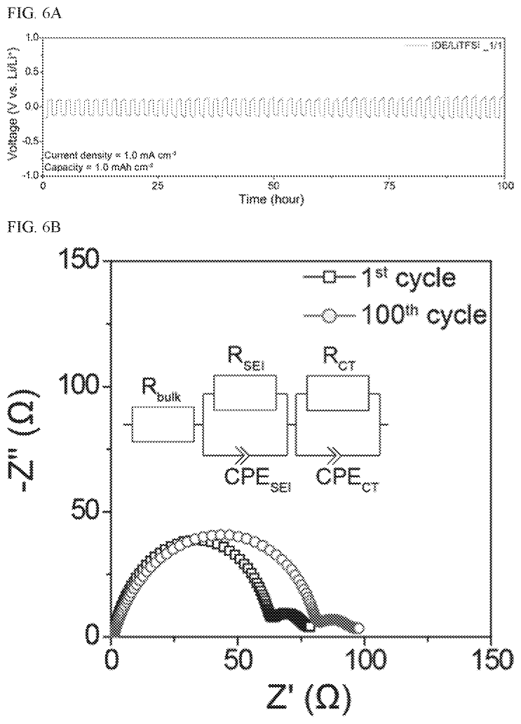

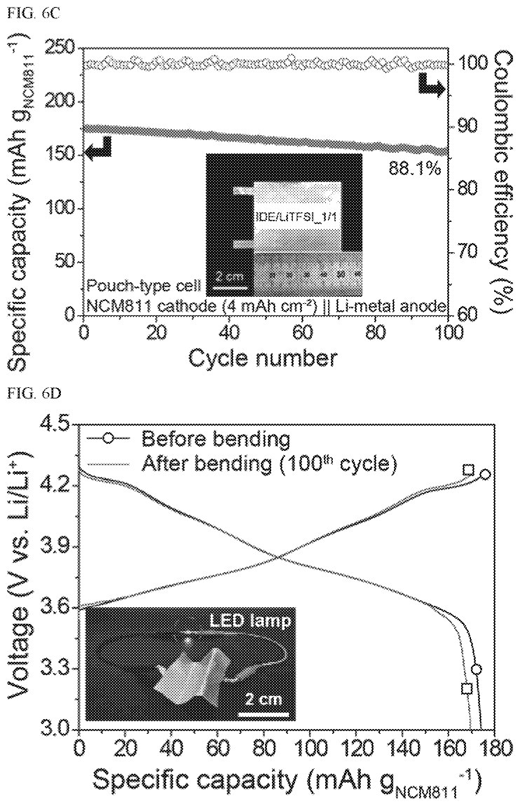

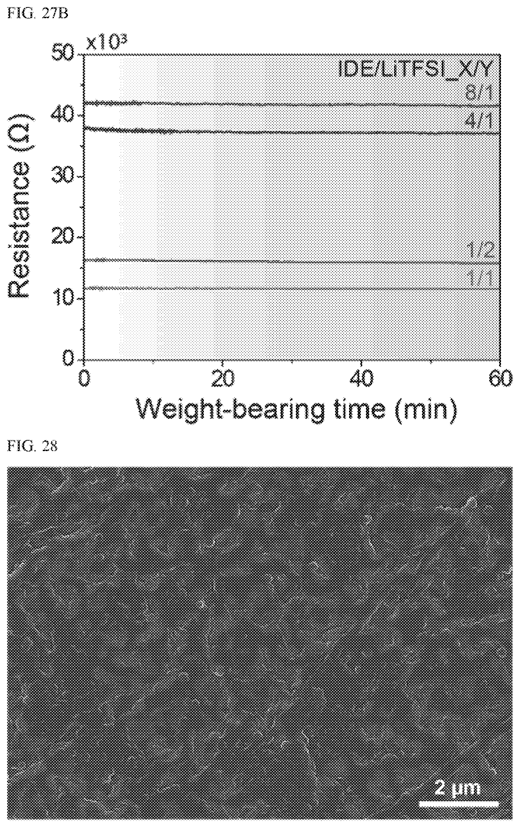

The potential of IDE/LiTFSI_1/1 as a solid electrolyte was evaluated using a lithium-to-lithium symmetric cell at a current density of 1.0 mA cm⁻² and a capacity of 1.0 mAh cm⁻² (FIG. 6A). Under these operating conditions, IDE/LiTFSI_1/1 exhibits stable and reliable lithium plating and stripping cycle behavior, owing to its enhanced lithium ion conductivity and excellent mechanical strength. The cycling stability of IDE/LiTFSI_1/1 was verified by analyzing the morphology of the lithium metal anode after 100 hours of cycling (FIG. 28). Uniform and dendrite-free lithium deposition was observed, indicating that IDE/LiTFSI_1/1 induces uniform lithium ion flux toward the lithium metal anode while suppressing interfacial side reactions. Furthermore, as confirmed in FIGS. 4A through 4F, the strong interfacial adhesion properties of IDE/LiTFSI_1/1 are expected to suppress dendrite growth by maintaining intimate and stable contact with the lithium metal anode. The stable cycling performance of the IDE/LiTFSI_1/1-based cell was confirmed by electrochemical impedance spectroscopy (EIS) analysis (FIG. 6B). During the cycling test, the cell resistance increased slightly, with the solid electrolyte interphase resistance (RSEI) increasing from 62.24Ω to 80.23Ω and the charge transfer resistance (RCT) increasing from 14.2 2 to 16.3 22 (after 100 hours). These results demonstrate that IDE/LiTFSI_1/1 holds promising potential as a polymer electrolyte for lithium metal anodes.

To explore the practical applicability of IDE/LiTFSI_1/1, a pouch-type all-solid-state battery (ASSB) full cell was fabricated in which IDE/LiTFSI_1/1 simultaneously serves as an ion-conducting separator and a solid cathode electrolyte. The full cell comprised an NCM811 cathode containing IDE/LiTFSI (areal capacity: 4.0 mAh cm⁻², equivalent to commercial lithium-ion battery cathode level) and a lithium metal anode (areal capacity: 4.0 mAh cm⁻², anode/cathode capacity ratio: 1.0). The pouch-type full cell demonstrated stable cycling performance under practical operating conditions (25 °C, 0.2 MPa), retaining 88.1% of its initial capacity after 100 cycles at a high current density of 1.0 C (4.0 mA cm⁻²) (FIG. 6C).

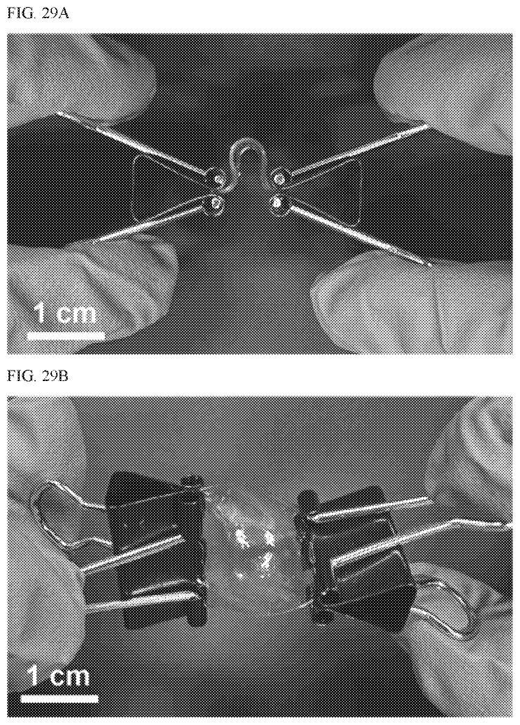

A major limitation of ASSBs employing inorganic solid electrolytes is their inherent mechanical rigidity, which restricts practical application in flexible energy storage systems. In contrast, by using IDE/LiTFSI_1/1, a highly deformable polymer electrolyte, the physical flexibility of the ASSB is secured (FIGS. 29A and 29B). This is because the cell components are integrated through in-situ polymerization. To quantitatively evaluate the mechanical flexibility of the ASSB, a pouch-type cell with dimensions of 2.0×2.0 cm² (areal capacity: 4.0 mAh cm⁻²) was fabricated and subjected to repetitive bending cycles. The cell maintained stable charge/discharge characteristics and cycling performance under practical operating conditions even after 100 bending cycles at a bending radius of 5 mm and a deformation rate of 30 mm min⁻¹ (FIG. 6D). Furthermore, the ASSB stably operated LED lighting even after multiple bending cycles, once again demonstrating its mechanical resilience (FIG. 6D).

While inorganic solid electrolytes have been actively studied for ASSBs, recent reports have raised concerns about the safety of ASSBs incorporating such electrolytes. To evaluate the safety performance of ASSBs incorporating IDE/LiTFSI_1/1, a safety test was performed by horizontally cutting the cell. Notably, even after cutting, the cell continued to operate LED lighting without explosion or structural collapse (FIG. 6E). Furthermore, the cut cell maintained its function even upon direct exposure to flame (FIG. 6E), demonstrating that IDE/LiTFSI_1/1 possesses excellent thermal stability and non-flammability. These results highlight the potential of IDE/LiTFSI_1/1 as a viable alternative to conventional inorganic solid electrolytes.

### 3. CONCLUSION

In summary, the present invention presents a novel IDE system that effectively combines high ionic conductivity and excellent mechanical toughness, demonstrating the ability to address important technical challenges in the development of ionic materials. A high-purity novel ionic dimer (ID) with strong ionic bonding of approximately 99% in the monomeric state was synthesized based on strong ionic bonds between imidazolium-based cationic monomers and sulfonate-based anionic monomers. The ID was polymerized together with cross-linkable functional groups to form a network, and by introducing LiTFSI salt into this network, a novel polymer (IDE) that is both mechanically robust and ionically conductive was obtained.

The resulting IDE/LiTFSI_1/1 exhibits outstanding electrochemical properties, achieving a high ionic conductivity of 0.82 mS cm⁻¹ and a lithium ion transference number (/Li⁺) of 0.79, outperforming previously reported ionic elastomers. The intrinsic ionic bonding network within IDE/LiTFSI_1/1 also contributes to excellent mechanical properties, with a tensile strength of 27.39 MPa and a Young's modulus of 211 MPa. In addition to its mechanical and electrochemical performance, IDE/LiTFSI demonstrates excellent adhesion to various substrates and operates effectively as a strain sensor, with a gauge factor (GF) of 2.92 and stable resistance characteristics maintained over approximately 400 repeated deformation cycles.

These properties suggest that the material holds potential for application in iontronics and energy storage technologies. Furthermore, the pouch-type full cell employing IDE/LiTFSI demonstrated stable cycling performance even under constrained cell conditions. Overall, IDE/LiTFSI serves as a multifunctional material platform with broad applicability to next-generation flexible iontronics and energy storage systems, providing a promising direction for the development of high-performance ionic materials.

### 4. EXPERIMENTAL SECTION/METHODS

[Materials] 1-Butylimidazole (purity 98%, Sigma-Aldrich), 2-bromoethyl acrylate (purity 94%, Alfa), acetonitrile (purity≥99.5%, Sigma-Aldrich), dichloromethane (DCM, purity≥99.8%, Sigma-Aldrich), deionized water (H₂O, Sigma-Aldrich), 3-sulfopropyl acrylate potassium salt (K[SPA], Sigma-Aldrich), and lithium bis(trifluoromethanesulfonyl)imide salt (LiTFSI, purity≥99.95%, Sigma-Aldrich) were vacuum-dried at 100 °C for 24 hours prior to storage in a glove box. In addition, deuterium oxide (D₂O, 99.9%, Sigma-Aldrich), poly(ethylene glycol) diacrylate (PEGDA, Sigma-Aldrich), 2-hydroxy-2-methylpropiophenone (photoinitiator, Sigma-Aldrich), ethanol (purity≥99.5%, Sigma-Aldrich), N,N-dimethylformamide (DMF, purity≥99.8%, Sigma-Aldrich), LiNi_{0.8}CO_{0.1}Mn_{0.1}O₂ (NCM811, LG Energy Solution), N-methyl-2-pyrrolidone (NMP, Sigma-Aldrich), and lithium metal foil (Honjo Metal Co., Ltd., thickness: 20 μm) were used.

[Synthesis of Ionic Dimer (ID)] Under a N₂ atmosphere, 5.0 g of 2-bromoethyl acrylate and 3.64 g of 1-butylimidazole were mixed in 30 mL of fresh acetonitrile and stirred at 65 °C overnight. After the reaction, acetonitrile was removed using a rotary evaporator, and the resulting 1-[2-acryloyloxyethyl]-3-butylimidazolium bromide ([AEBI]Br) was extracted with deionized water and washed with dichloromethane at least 5 times. After washing, deionized water was removed in a vacuum oven at 70 °C. Subsequently, 2.351 g of [AEBI]Br was dissolved in 30 g of acetonitrile, and an equimolar amount of K[SPA] (2.46 g) was added, followed by stirring at 65 °C overnight. After the reaction, 1.23 g of KBr precipitate was removed by filter paper, and acetonitrile was removed from the remaining clear solution by a rotary evaporator to concentrate it. The weight of the [AEBI][SPA] dimer obtained through the reaction was 3.46 g, with a yield of 98.38%. The [AEBI][SPA] dimer was sealed and stored in a glove box.

[Fabrication of Ionic Dimer-Based Elastomer (IDE)] 0.2 g of [AEBI][SPA] dimer, PEGDA (molecular weight: 700 g mol⁻¹, 2 wt %), and HOMPP (photoinitiator, 2 wt %) were dissolved in ethanol or DMF (0.1 g). This solution was poured into a polydimethylsiloxane (PDMS) mold and polymerized by UV irradiation for 120 seconds to undergo gelation. The polymerized [AEBI][SPA] dimer was dried in a vacuum oven at 65 °C for 24 hours or more to remove the solvent.

[Thermal and Mechanical Characterization] The mechanical properties of IDE and IDE/LiTFSI samples were measured at room temperature (25 °C) using a tensile tester (Mecmeshine, 50 N load cell). Dog-bone shaped samples were subjected to uniaxial tensile testing at a rate of 60 mm min⁻¹, and Young's modulus was defined as the initial slope of the tensile stress-strain curve. IDE/LiTFSI_1/1 samples were prepared by cutting a linear notch of 4 mm in length from the edge to the center using a sharp blade. The fracture energy (T) value was calculated by multiplying the area under the stress-strain curve of the unnotched sample and the area up to the critical strain (cc) just before crack propagation in the notched sample by the gauge length between the clamps. Here, A denotes the fracture surface area and F denotes the applied stress, and the calculation formula is as follows:

$$Γ = {A}^{- 1} \times {\int }_{0}^{{ε}_{c}} F d ε$$

The rheological properties of IDE/LiTFSI samples were measured using an MCR 702e (Anton Paar) with a parallel plate geometry of 4 mm diameter and samples with a thickness of 1 mm or more, under a strain condition of 1%. The thermal properties of IDE and IDE/LiTFSI samples were analyzed using DSC (Discovery DSC 250 Auto, TA Instruments) at a heating and cooling rate of 10 °C min⁻¹. Residual solvent analysis was performed using TGA (SDT 500, TA Instruments) over a temperature range from 30 °C to 400 °C. GPC analysis was performed using a Tosoh (EcoSEC HLC-8420 GPC) system with 0.1 M NaNO₃ as the mobile phase at a flow rate of 1 mL min⁻¹.

[Structural and Physicochemical Characterization] The ¹H NMR and ¹³C NMR spectra of the ionic dimer (ID) and ionic dimer elastomer (IDE) were measured using a Bruker Avance III HD 300 instrument operating at 300 MHz and 125 MHz, respectively. D₂O was used as the NMR solvent depending on the solubility of the samples. ¹H and ⁷Li NMR (Bruker BioSpin, Avance III HD500) were used for diffusion-ordered spectroscopy (DOSY) to measure diffusion coefficients. These measurements were performed at the Chronic Metabolic Disease Research Institute of Sookmyung Women's University. UV-vis spectra were obtained using a Cary 5000 UV-vis spectrometer, and ATR-FTIR spectroscopy was performed using a Bruker Vertex 70 instrument. The surface morphology and height deviation of unpressed electrodes were analyzed using laser scanning confocal microscopy (FV1000, Carl Zeiss), and the height deviation was defined as the difference between the observed height and the average height of the electrolyte. Powder XRD patterns were collected using a Rigaku MiniFlex600 diffractometer with Cu Kα radiation (wavelength=1.5406 Å), and measurements were performed by mounting an XRD cell containing the sample onto the diffractometer at 40 kV and 15 mA. The surface and cross-sectional morphology of the electrodes were analyzed by field emission scanning electron microscopy (FE-SEM; S-4800, Hitachi).

[Electrochemical Characterization] The ionic dissociation constant (¿) is generally estimated by comparing the ionic conductivity obtained from EIS with the molar conductivity obtained from PFG-NMR. EIS is an experimental method that enables rapid determination of the ionic conductivity of a system by measuring the impedance applied across the cell, and unlike the conductivity calculated by the Nernst-Einstein equation, it measures only the “free ions” that actually contribute to ionic conduction within the system. Therefore, the ionic dissociation constant (8) can be estimated by dividing the molar conductivity obtained from EIS measurements by the molar conductivity calculated through PFG-NMR and the Nernst-Einstein equation.

$$ξ = \frac{{λ}_{EIS}}{{C}_{IL} {Λ}_{N E}}$$

where λEIS is the ionic conductivity measured by EIS and CIL is the molar concentration of ID per unit volume. The Nernst-Einstein equation relates the diffusion coefficient of [AEBI]⁺ (D₊) and the diffusion coefficient of [SPA] (D-) to the molar conductivity (ΛNE):

$${Λ}_{N E} = \frac{{N}_{A} {e}^{2}}{{k}_{B} T} ( {z}_{+}^{2} {D}_{+} + {z}_{-}^{2} {D}_{-} )$$

where NA is Avogadro's number, e is the elementary charge, kB is the Boltzmann constant, T is the absolute temperature, and z₊ and z₋ are the charge numbers of [AEBI]⁺ and [SPA], respectively. D₊ and D₋ are measured by PFG-NMR, which detects atomic nuclei (e.g., ⁷Li and ¹H) without distinguishing ion pairing or aggregation states, thereby providing average self-diffusion coefficients. The measured self-diffusion coefficients D of [AEBI]⁺ and [SPA] are 8.881×10⁻¹² and 5.772×10⁻¹² m² s⁻¹, respectively. The ΛNE value calculated from Equation 2 is thereby 6.39×10³⁴ e² s kg⁻¹ mol⁻¹. Additionally, the λEIS of ID measured by EIS is 0.0549 mS cm⁻¹, and CIL is 0.95×10⁻³ mol cm⁻³. The ionic conductivity of the electrodes was estimated by EIS analysis over a frequency range of 10-2 to 106 Hz with an applied voltage amplitude of 10 mV, using a VSP Classic potentiostat (Bio-Logic). Impedance was measured from 25 to 80 °C, and the ionic conductivity was calculated using the following equation:

$$σ = \frac{L}{R A}$$

where L is the thickness of the electrolyte pellet, R is the resistance, and A is the contact area with the electrode. The activation energy (Eₐ) of ionic conductivity was calculated from the slope of the Arrhenius plot. The electrochemical stability window of the electrolyte was evaluated by linear sweep voltammetry (LSV) analysis at a scan rate of 0.1 mV s⁻¹, with a carbon electrode used as the working electrode. The lithium ion transference number (Li⁺) was evaluated using the potentiostatic polarization method, by applying DC polarization through a non-blocking symmetric cell and sequentially analyzing EIS before and after polarization:

$${t}_{Li +} = \frac{{I}_{s} ( Δ V - {I}_{o} {R}_{o} )}{{I}_{o} ( Δ V - {I}_{s} {R}_{s} )}$$

where V is the applied voltage, Io and Ro are the initial current and resistance, and Is and Rs are the steady-state current and resistance after polarization, respectively. EIS fitting for the electrochemical system was performed using potentiostat software (VSP Classic, Bio-Logic) based on an equivalent circuit comprising passive elements such as resistors and capacitors, as well as distributed elements, and the measured impedance data were interpreted by fitting to the model circuit. Lithium metal anode cycling tests were performed using Li∥Li symmetric cells at a current density of 1.0 mA cm⁻² and an areal capacity of 1.0 mAh cm⁻² at 25 °C, and the charge/discharge characteristics of the cells were analyzed using a cycle tester (PNE Solution).

[Fabrication of Resistive-Type Iontronic Devices] Rigid PDMS was prepared by mixing PDMS base and curing agent at a mass ratio of 10:1. The mixed rigid PDMS solution was degassed in a vacuum oven to remove internal air bubbles, then cured at 65 °C overnight to a thickness of 1 mm. IDE/LiTFSI was transferred and attached onto the rigid PDMS, and copper tape (Cu tape) was attached to both ends of IDE/LiTFSI. The contact area between the copper tape and IDE/LiTFSI was 0.2×1.0 cm². The IDE/LiTFSI with attached copper tape was encapsulated with the remaining rigid PDMS, and the upper and lower rigid PDMS layers were strongly bonded using an O₂ plasma system.

[Fabrication of Electrodes and All-Solid-State Battery (ASSB) Full Cells] The cathode slurry was prepared by mixing NCM811, carbon black, and polyvinylidene fluoride (PVDF) at a mass ratio of 96/2/2. PVDF was used as the sole binder for the cathode and was dissolved in NMP for 12 hours prior to use. The concentration of the binder solution was standardized at 10 wt %. The cast cathode slurry was vacuum-dried at 120 °C for 12 hours, followed by calendering at 60 °C. The cathode was fabricated by casting the slurry onto an Al current collector, followed by vacuum drying at 80 °C for 12 hours and subsequent calendering at 120 °C. The active material areal mass loading of the cast cathode was 21.0 mg cm⁻². A thin lithium metal foil was used as the anode for the full cell. The pouch-type cell comprised an NCM811 cathode (4.0 mAh cm⁻²) and a lithium metal anode with an N/P ratio of 1.0, and an aluminum pouch film was used as the packaging material. All assembly was performed in a dry room with a dew point of −60 °C. The electrochemical performance of the pouch-type cell was evaluated at 25 °C under a constant pressure of 200 kPa.

TABLE 1
Compositions of ID and LiTFSI used in the present invention.

| | | LiTFSI | |
|---|---|---|---|
| Sample code (IDE/ | Molar ratio (X/Y = | content | Physical |
| LiTFSI X/Y) | ID/LiTFSI) | (wt. %) | state |
| IDE/LiTFSI_8/1 | 8:01 | 8.625 | Solid |
| IDE/LiTFSI_4/1 | 4:01 | 17.25 | Solid |
| IDE/LiTFSI_1/1 | 1:01 | 69 | Solid |
| IDE/LiTFSI_1/2 | 1:02 | 138 | Solid |

TABLE 2
Calculation details of the ionic dissociation constant (ξ) of the [AEBI][SPA]
dimer measured by PFG-NMR and EIS methods.

| | D⁻ of | D⁺ of | | | | |
|---|---|---|---|---|---|---|
| | [SPA]⁻ | [AEBI]⁺ | Λ_EIS | C_IL | Λ_NE | |
| | monomer | monomer | (mS | (mol | (e² · sec · | |
| [AEBI][SPA] | (m² s⁻¹) | (m² s⁻¹) | cm⁻¹) | cm⁻³) | kg⁻¹ · mol⁻¹) | ξ |
| — | 5.772 × | 8.881 × | 0.0549 | 0.95 × | 6.39 × | 0.0035 |
| | 10⁻¹³ | 10⁻¹³ | | 10⁻³ | 10³⁴ | |

TABLE 3
Calculation details of the lithium ion transference number (tLi⁺) of
IDE/LiTFSI_1/1 measured by the potentiostatic polarization method.

| Sample | Applied voltage (mV) | I₀ (μA) | I_s (μA) | R₀ (Ω) | R_s (Ω) | t_Li⁺ |
|---|---|---|---|---|---|---|
| IDE/LiTFSI_1/1 | 10 | 44.2 | 41.16 | 259.1 | 284.64 | 0.79 |

TABLE 4
Comparison of RS, RSEI, and RCT values fitted from
EIS curves for IDE before and after cycling tests.

| Sample | Cycle | | R_s (Ω) | R_SEI (Ω) | R_CT (Ω) |
|---|---|---|---|---|---|
| IDE/LiTFSI_1/1 | 1st | cycle | 1.16 | 62.24 | 14.2 |
| IDE/LiTFSI_1/1 | 100th | cycle | 1.27 | 80.23 | 16.3 |

Although the present invention has been described above with reference to preferred embodiments thereof, those skilled in the art will appreciate that various modifications and changes may be made to the present invention without departing from the spirit and scope of the present invention as set forth in the claims below.

What is claimed is:

1. A polymeric elastomer material with improved mechanical properties and ionic conductivity, comprising: a cross-linked polymer chain; a cationic functional group branched from the polymer chain; and an anionic functional group that is ionically bonded to the cationic functional group and branched from the polymer chain.

2. The polymeric elastomer material of claim 1, wherein the cross-linked polymer chain comprises a poly acrylate-based chain.

3. The polymeric elastomer material of claim 1, wherein the cationic functional group comprises an imidazolium-based cation.

4. The polymeric elastomer material of claim 3, wherein the imidazolium-based cation is derived from AEBI (1-(2-Acryloyloxyethyl)-3-butylimidazolium).

5. The polymeric elastomer material of claim 1, wherein the anionic functional group comprises a sulfonate-based anion.

6. The polymeric elastomer material of claim 5, wherein the sulfonate-based anion is derived from SPA (3-Sulfopropyl Acrylate).

7. The polymeric elastomer material of claim 1, wherein the polymer chain is further cross-linked with PEGDA (Poly (ethylene glycol) diacrylate).

8. The polymeric elastomer material of claim 1, wherein the polymeric elastomer material further comprises mobile lithium (Li) cations and TFSI (bis(trifluoromethanesulfonyl)imide) anions therein.

9. A method of manufacturing a polymeric elastomer material with improved mechanical properties and ionic conductivity, comprising: mixing a cationic monomer comprising a polymerizable functional group and a cationic functional group, a counter-anion of the cationic monomer, an anionic monomer comprising a polymerizable functional group and an anionic functional group, and a counter-cation of the anionic monomer; removing a precipitate formed by the counter-anion and the counter-cation; and cross-linking the cationic monomer and the anionic monomer.

10. The method of claim 9, wherein the counter-anion comprises Br and the counter-cation comprises K⁺.

11. The method of claim 9, wherein the cationic monomer comprises AEBI (1-(2-Acryloyloxyethyl)-3-butylimidazolium).

12. The method of claim 9, wherein the anionic monomer comprises SPA (3-Sulfopropyl Acrylate).

13. The method of claim 9, wherein the cross-linking comprises cross-linking by UV photopolymerization or chemical cross-linking.

14. The method of claim 9, wherein the method further comprises adding LiTFSI (Lithium bis(trifluoromethanesulfonyl)imide) salt prior to the cross-linking.

15. The method of claim 9, wherein the method further comprises further cross-linking the cationic monomer and the anionic monomer with PEGDA (Poly (ethylene glycol) diacrylate).
